(19) United States
(12) Patent Application Publication
(10) Pub. No.: US 2026/0267273 A1
(43) Pub. Date: Sep. 10, 2026

(54) MEDIUM PROCESSING APPARATUS, IMAGE FORMING SYSTEM, AND NON-TRANSITORY RECORDING MEDIUM

(71) Applicants: Kotomi KAMEYAMA, Kanagawa (JP); Yuusuke SHIBASAKI, Tokyo (JP); Wataru TAKAHASHI, Tokyo (JP); Tomomichi HOSHINO, Kanagawa (JP); Atsushi SHINODA, Kanagawa (JP); Shota YOSHIDA, Kanagawa (JP); Sho ASANO, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Kotomi KAMEYAMA, Kanagawa (JP); Yuusuke SHIBASAKI, Tokyo (JP); Wataru TAKAHASHI, Tokyo (JP); Tomomichi HOSHINO, Kanagawa (JP); Atsushi SHINODA, Kanagawa (JP); Shota YOSHIDA, Kanagawa (JP); Sho ASANO, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA Co., Ltd., Kanagawa (JP)

(21) Appl. No.: 19/444,977

(22) Filed: Jan. 9, 2026

(30) Foreign Application Priority Data
Jan. 16, 2025 (JP) 2025-006407

(51) Int. Cl. G03G 15/00; B42C 1/12; B65H 29/20; B65H 33/06; B65H 37/04

(52) U.S. Cl. CPC G03G 15/6544; B65H 29/20; G03G 15/6573; B42C 1/12; B65H 33/06; B65H 37/04; B65H 2301/163; G03G 2215/00421; G03G 2215/00827; G03G 2215/00864

(57) ABSTRACT

A medium processing apparatus includes a first conveyor, a second conveyor, a stacker, a binder, and a driver. The first conveyor nips a medium and rotates to convey the medium in a first conveyance direction. The second conveyor rotates while contacting an upper face of the medium that has passed through the first conveyor, and convey the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between a conveyance position where the second conveyor contacts the medium on the stacker to convey the medium and a retraction position where the second conveyor is retracted from the medium on the stacker.

### CROSS-REFERENCE TO RELATED APPLICATION

This patent application is based on and claims priority pursuant to 35 U.S.C. § 119(a) to Japanese Patent Application No. 2025-006407, filed on Jan. 16, 2025, in the Japan Patent Office, the entire disclosure of which is hereby incorporated by reference herein.

### BACKGROUND

### Technical Field

Embodiments of the present disclosure relate to a medium processing apparatus, an image forming system, and a non-transitory recording medium.

### Background

Typical medium processing apparatuses in the art are known that bind media (“media bundle”) stacked on a processing tray. Such medium processing apparatuses in the art provides a technique of raising and lowering the return belt contacting the upper face of the medium placed on the processing tray according to the number of media in the media bundle.

However, in a medium processing apparatus in the art, since a dedicated motor is used to raise and lower the return belt, an increase in size and an increase in cost of the apparatus become problems.

### SUMMARY

Embodiments of the present disclosure described herein provide a novel medium processing apparatus including a first conveyor, a second conveyor, a stacker, a binder, and a driver. The first conveyor nips a medium and rotate to convey the medium in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between a conveyance position where the second conveyor contacts the medium on the stacker to convey the medium and a retraction position where the second conveyor is retracted from the medium on the stacker.

Further, embodiments of the present disclosure described herein provide an image forming system including an image forming apparatus to form an image on a medium, and the above-described medium processing apparatus to process the medium supplied from the image forming apparatus.

Further, embodiments of the present disclosure described herein provide an image forming system including an image forming apparatus, a first conveyor, a second conveyor, a stacker, a binder a driver, a receiver, an opening, and circuitry. The image forming apparatus forms an image on a medium. The first conveyor nips a medium and rotates to convey the medium supplied from the image forming apparatus in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between a conveyance position where the second conveyor contacts the medium on the stacker to convey the medium and a retraction position where the second conveyor is retracted from the medium on the stacker. The receiver receives an operational input. The opening is an opening through which the media is fed from outside to the stacker. The circuitry is to control the driver and the binder, move the second conveyor from the conveyance position to the retraction position when a binding instruction as the operational input is input to the receiver, cause the binder to bind the media fed to the stacker through the opening, cause the binder to bind the plurality of the media manually fed through the opening, and cause the image forming apparatus to wait for image formation until the media bound by the binder is ejected through the opening, in a case where the image forming apparatus is instructed to form an image, with the second conveyor in the retraction position.

Further, embodiments of the present disclosure described herein provide a non-transitory recording medium storing a program which, when executed by one or more processors of a medium processing apparatus, causes the one or more processors to perform a method, including controlling a driver to move a second conveyor to a conveyance position and a retraction position. The medium processing apparatus includes a first conveyor, the second conveyor, a stacker, a binder, and the driver. The first conveyor nips a medium and rotates to convey the medium supplied from the image forming apparatus in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between the conveyance position where the second conveyor contacts the medium on the stacker to convey the medium and the retraction position where the second conveyor is retracted from the medium on the stacker.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an internal configuration of an image forming apparatus;

FIG. 2A is a side view illustrating an internal configuration of a binding processing apparatus according to a first embodiment;

FIG. 2B is a plan view illustrating a position of a conveyance path;

FIG. 3 is a plan view illustrating a position of an internal tray of the binding processing apparatus according to the first embodiment;

FIGS. 4A and 4B are diagrams each illustrating a state of the binding processing apparatus until a sheet reaches a conveyance roller pair;

FIGS. 5A and 5B are diagrams each illustrating a state of the binding processing apparatus performing a binding process;

FIG. 6 is a diagram illustrating the binding processing apparatus in the state illustrated in FIG. 5B as viewed from a sheet thickness direction;

FIGS. 7A and 7B are diagrams illustrating the state of the binding processing apparatus in a case where a sheet bundle subjected to the binding process is ejected to a second ejection tray;

FIG. 8 is a diagram illustrating a state where a conveyance roller pair is at a release position and a return roller is at a conveyance position;

FIG. 9A is an enlarged view of a rotation driving mechanism;

FIG. 9B is an enlarged view of a return roller;

FIG. 10A is a diagram illustrating the return roller at a conveyance position;

FIG. 10B is a diagram illustrating the return roller at a retraction position;

FIG. 11 is a diagram illustrating a state where the conveyance roller pair is at an engagement position and the return roller is at a conveyance position;

FIG. 12 is a diagram illustrating a state where the conveyance roller pair is at an engagement position and the return roller is at a conveyance position;

FIG. 13 is an example of a hardware configuration diagram of the image forming apparatus;

FIG. 14 is another example of the hardware configuration diagram of the image forming apparatus;

FIG. 15 is a flowchart of a manual binding control process 1;

FIG. 16A is a flowchart of a retraction position movement process;

FIG. 16B is flowchart of a conveyance position movement process;

FIG. 17A is a screen example of a mode selection screen;

FIG. 17B is a screen example of a manual binding start screen;

FIGS. 18A and 18B are diagrams illustrating a position of a side fence in the manual binding control process 1;

FIG. 19 is a flowchart of a manual binding control process 2;

FIG. 20 is a flowchart of a manual binding control process 3;

FIG. 21 is a diagram of a binding processing apparatus according to a second embodiment as viewed from a sheet thickness direction;

FIG. 22 is a flowchart of a manual binding control process 4;

FIG. 23 is a flowchart of a manual binding control process 5;

FIGS. 24A and 24B are views illustrating a shape of a protrusion according to a third embodiment; and

FIGS. 25A to 25C are views illustrating a state of the return roller when a pin is moved in a main scanning direction.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Referring now to the drawings, embodiments of the present disclosure are described below. As used herein, the singular forms “a,” “an,” and “the” are intended to include the plural forms as well, unless the context clearly indicates otherwise.

A description is given of an image forming apparatus 1 according to the present disclosure, with reference to the drawings.

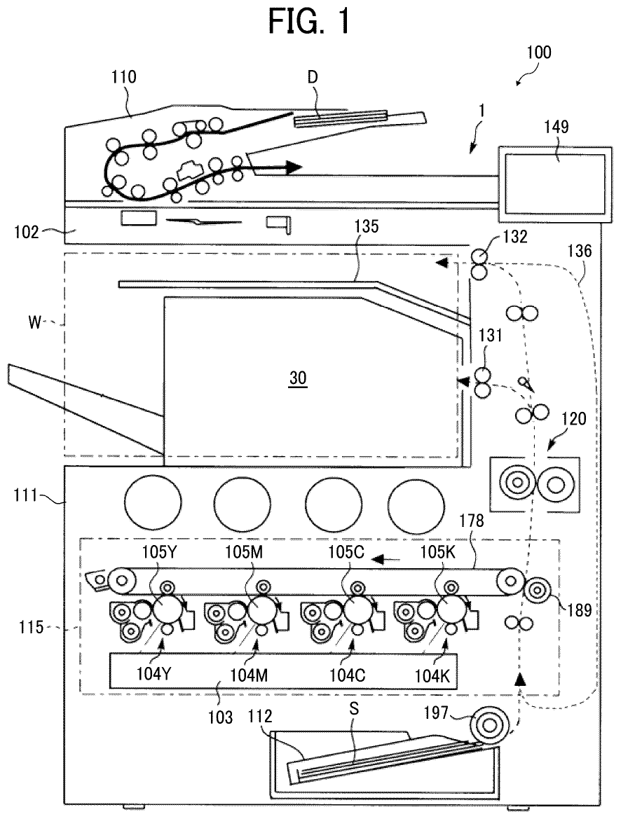

FIG. 1 is a diagram illustrating an internal configuration of the image forming apparatus 1.

The image forming apparatus 1 is an apparatus that forms an image on a sheet S which is an example of a sheet-like medium (representatively, a sheet of paper). As illustrated in FIG. 1, the image forming apparatus 1 mainly includes a housing 111 and an image forming device 115 (image forming device).

The housing 111 has a box shape to form an internal space for accommodating components of the image forming apparatus 1. The housing 111 has an in-body space W that is accessible from the outside of the image forming apparatus 1. The in-body space W is located, for example, slightly above the center of the housing 111 in the vertical direction. An outer wall of the housing 111 has been cut out to expose the in-body space W to the outside. In the in-body space W, a processing apparatus (for example, an optional apparatus, a binding processing apparatus 30) that performs various types of processing on the sheet S on which an image is formed by the image forming device 115 is arranged. The in-body space W is a space to which the sheet S ejected from the image forming apparatus 1 can be ejected, and is also a space from which the ejected sheet S can be taken out.

In the in-body space W of the image forming apparatus 1, for example, as illustrated in FIG. 1, the binding processing apparatus 30 (medium processing apparatus) is arranged. In this configuration, a plurality of sheets S on which an image is formed by the image forming device 115 is subjected to a binding process by the binding processing apparatus 30 and ejected to a second ejection tray 32.

As another example, the optional apparatus and the binding processing apparatus 30 may be arranged in the in-body space W of the image forming apparatus 1. In this configuration, the plurality of sheets S on which an image is formed by the image forming device 115 is subjected to a process (for example, a liquid applying process for a binding position, a punching process for a punch hole, or a folding process) by the optional apparatus, then subjected to the binding process by the binding processing apparatus 30, and ejected to the second ejection tray 32.

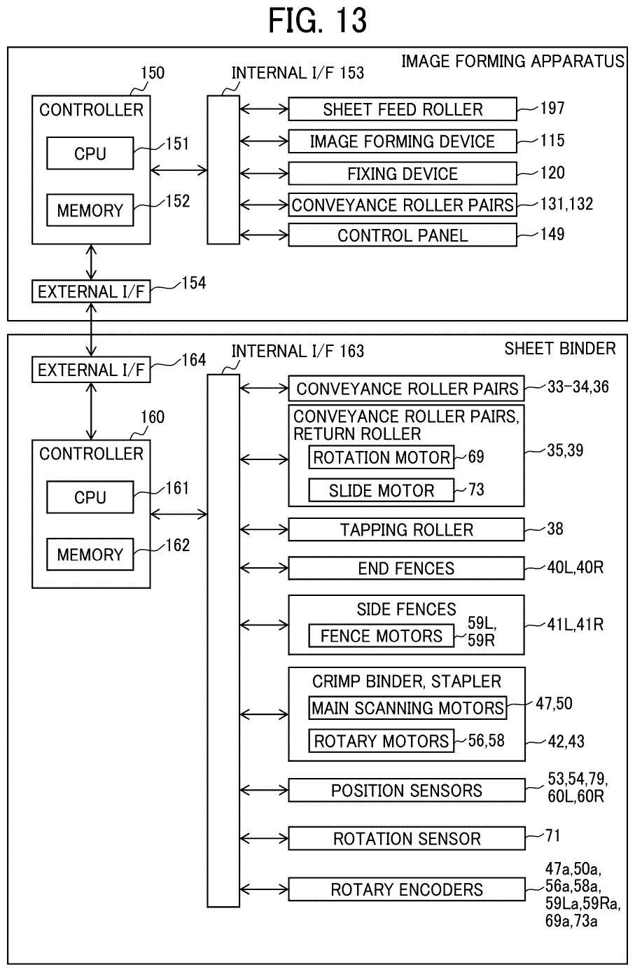

Each of the optional apparatus and the binding processing apparatus 30 is made a unit and has an input and output interface that can be connected to each other to convey the sheet S. In other words, an optional apparatus 20 and the binding processing apparatus 30 are replaceable according to the application of the image forming apparatus 1. More particularly, the input interfaces of the optional apparatus and the binding processing apparatus 30 can be connected to the output interface of the image forming device 115. The input interface of the binding processing apparatus 30 can also be connected to the output interface of the optional apparatus. Adjacent units are detachably coupled to each other by, for example, a mechanical lock or a magnet. The apparatuses arranged in the in-body space W are each connected to a controller 150 (see FIG. 13) via a harness for transmitting and receiving various signals.

As still another example, the image forming apparatus 1 may be included in an image forming system 100 in combination with a post-processing apparatus mounted outside the in-body space W. The post-processing apparatus may be, for example, an apparatus that performs a sorting process of sorting a sheet bundle Sb (media bundle) ejected from the binding processing apparatus 30. In the in-body space W of the image forming apparatus 1, a relay device that relays the sheet S on which an image is formed and which has been ejected into the in-body space W to the post-processing apparatus may be arranged. The relay device may be integrated with the post-processing apparatus, or may be separately configured and mounted. The post-processing apparatus may be the binding processing apparatus 30.

The image forming apparatus 1 mainly includes a document conveying device 110, a document reading device 102, a feeding tray 112, a sheet feed roller 197, the image forming device 115, a fixing device 120, conveyance roller pairs 131 and 132 (conveying unit), and a first ejection tray 135. In the present description, an example of the image forming device 115 of an electrophotographic type that forms images using toner will be described, but an inkjet type that forms images using ink may also be used.

The document conveying device 110 conveys a document D on which an image has already been formed toward the document reading device 102. The document reading device 102 optically reads the image on the document D conveyed by the document conveying device 110 and generates image data. As a reading element of the document reading device 102, for example, a charge coupled device (CCD) sensor, or a complementary metal oxide semiconductor (CMOS) sensor can be used.

The feeding tray 112 laminates and accommodates the plurality of sheets S. The sheet feed roller 197 feeds the sheets S accommodated in the feeding tray 112 one by one toward the image forming device 115. The image forming device 115 forms an image indicated by the image data generated by the document reading device 102 (alternatively, received from an external device via a communication network) on the sheet S fed by the sheet feed roller 197. The image forming device 115 includes a writing device 103, image forming units 104Y, 104M, 104C, and 104K, an intermediate transfer belt 178, and a secondary transfer roller 189.

The writing device 103 converts the image indicated by the image data into laser beams of a plurality of colors (yellow, magenta, cyan, and black), and irradiates photoconductor drums 105Y, 105M, 105C, and 105K of the image forming units 104Y, 104M, 104C, and 104K with the laser beams. As a result, images of corresponding colors are formed on the surfaces of the photoconductor drums 105Y, 105M, 105C, and 105K. Images of respective colors on the photoconductor drums 105Y, 105M, 105C, and 105K are superimposed and transferred onto the intermediate transfer belt 178, forming a color image. The secondary transfer roller 189 transfers the color image on the intermediate transfer belt 178 to the sheet S fed by the sheet feed roller 197, and conveys the sheet S to the fixing device 120.

The fixing device 120 fixes the image transferred to the sheet S by the secondary transfer roller 189 and conveys the image to the conveyance roller pairs 131 and 132. The conveyance roller pair 131 conveys the sheet S which has passed through the fixing device 120 toward the binding processing apparatus 30 arranged in the in-body space W. The conveyance roller pair 132 conveys the sheet S which has passed through the fixing device 120 toward the first ejection tray 135 arranged in the in-body space W. Alternatively, the conveyance roller pair 132 inverts the front and back of the sheet S which has passed through the fixing device 120 through an inverting conveyance path 136 and supplies the sheet S to the image forming device 115 again. The destination of the sheet S which has passed through the fixing device 120 is switched by, for example, a user operation (or an instruction from an external device) through a control panel 149.

### First Embodiment

### Configuration of Binding Processing Apparatus

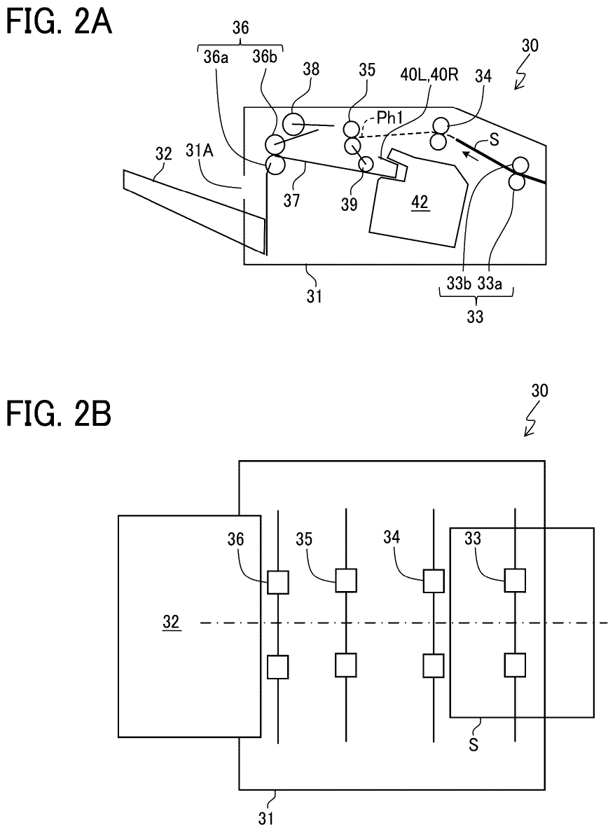

FIG. 2A is a side view illustrating an internal configuration of the binding processing apparatus 30 according to a first embodiment.

FIG. 2B is a plan view illustrating a position of a conveyance path Ph1.

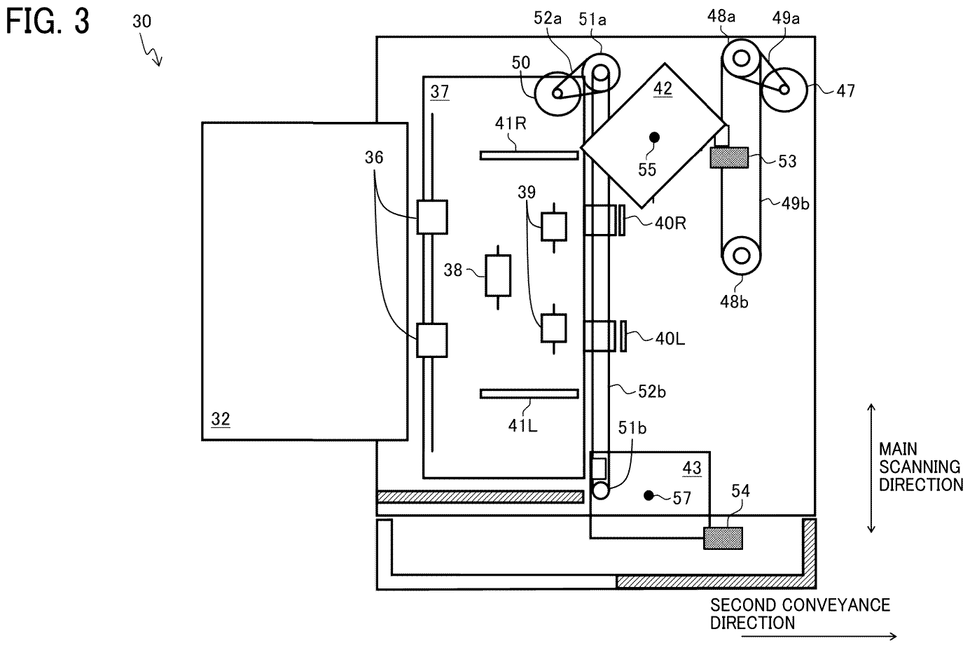

FIG. 3 is a plan view illustrating a position of an internal tray 37 of the binding processing apparatus 30 according to the first embodiment.

The binding processing apparatus 30 performs the binding process (post-process) of binding the plurality of sheets S (sheet bundle Sb) on which images have been formed by the image forming device 115. As illustrated in FIGS. 2A, 2B and 3, the binding processing apparatus 30 includes a binding case 31 (apparatus body), the second ejection tray 32, a plurality of conveyance roller pairs 33, 34, 35, and 36 (conveyors), the internal tray 37 (stacker), a tapping roller 38, a return roller 39 (second conveyor), end fences 40L and 40R (conveyance direction aligner), side fences 41L and 41R (main scanning direction aligner), a crimp binder 42 (binder), and a staple binder 43 (binder).

In the present specification, a direction toward the second ejection tray 32 along the conveyance path Ph1 is referred to as a “first conveyance direction”, and a direction toward the end fences 40L and 40R along the upper face of the internal tray 37 is referred to as a “second conveyance direction”. In other words, the first conveyance direction and the second conveyance direction are different from each other. More particularly, the first conveyance direction and the second conveyance direction are different from each other in the same plane (plane orthogonal to the width direction of the sheet S). A direction (that is, the width direction of the sheet S) orthogonal to the first conveyance direction, the second conveyance direction, and the thickness direction of the sheet S supported by the internal tray 37 is referred to as a “main scanning direction”.

The binding case 31 as an apparatus body has a box shape to form an internal space for accommodating components of the binding processing apparatus 30. The conveyance path Ph1 is formed in the internal space of the binding case 31. The conveyance path Ph1 is a space through which the sheet S passes. The second ejection tray 32 is supported on an outer side surface of the binding case 31. The second ejection tray 32 stacks the sheet S or the sheet bundle Sb conveyed by the conveyance roller pairs 33 to 36.

The conveyance roller pairs 33 to 36 are arranged on the conveyance path Ph1 at predetermined intervals. The conveyance roller pairs 33 to 36 convey the sheet S along the conveyance path Ph1. The conveyance roller pair 33 is configured of a driving roller 33a and a driven roller 33b that are arranged to face each other across the conveyance path Ph1. The driving roller 33a and the driven roller 33b are rotatably supported by the binding case 31. A rotary driving force of a conveyance motor is transmitted to the driving roller 33a to rotate the driving roller 33a forward in a direction of conveying the sheet S (counterclockwise direction in FIGS. 2A and 2B). The driven roller 33b is arranged to face the driving roller 33a across the conveyance path Ph1 and is driven by the rotation of the driving roller 33a. As the conveyance motor is driven with the driving roller 33a and the driven roller 33b nipping the sheet S, the sheet S is conveyed along the conveyance path Ph1.

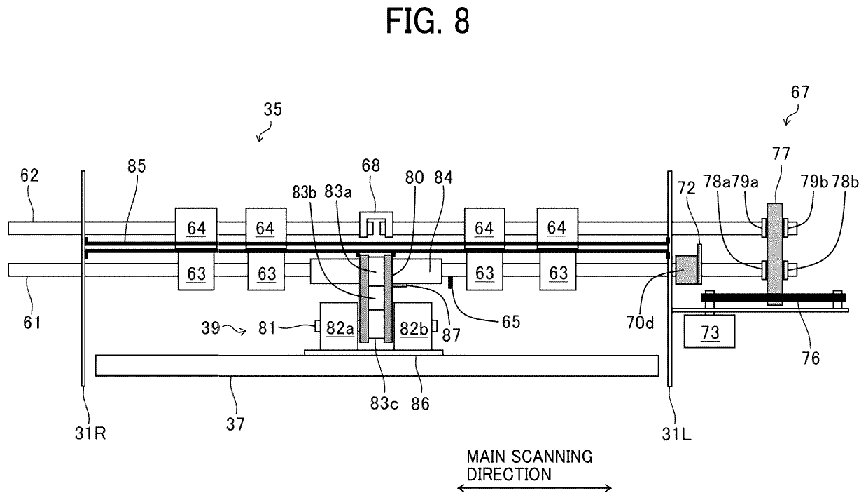

The basic configuration of the conveyance roller pairs 34 to 36 is common to the conveyance roller pair 33. The conveyance roller pair 36 includes a driving roller 36a and a driven roller 36b that can be brought into contact with and separated from the driving roller 36a. The conveyance roller pair 35 (first conveyor) is a so-called “shift roller” that is slidable in a width direction in order to implement a sorting process in which the sheet S is shifted in the width direction and ejected to the second ejection tray 32. A specific configuration of the conveyance roller pair 35 will be described below with reference to FIGS. 8 to 12.

The internal tray 37 temporarily supports (stacks) the plurality of sheets S conveyed by the conveyance roller pair 36. The tapping roller 38 is supported at an end of a rotation arm above the internal tray 37. As the rotation arm is rotated, the tapping roller 38 supplies the sheet S to the internal tray 37. The return roller 39 rotates while contacting the upper face of the sheet S supported by the internal tray 37 to guide the sheet S toward the conveyance roller pair 36.

The end fences 40L and 40R contact the downstream end in the first conveyance direction of the sheet S supported by the internal tray 37 to align the position in the conveyance direction of the sheet S. The side fences 41L and 41R contact both ends in the main scanning direction of the sheet S supported by the internal tray 37 to align the position in the main scanning direction of the sheet S. More particularly, the side fences 41L and 41R can be moved independently in the main scanning direction by transmission of the driving force of fence motors 59L and 59R (see FIG. 13).

The binding processing apparatus 30 includes position sensors 60L and 60R (see FIG. 13). The position sensors 60L and 60R detect that the side fences 41L and 41R are arranged at standby positions in the main scanning direction. The standby position is, for example, a position where the interval in the main scanning direction is the farthest (in other words, it is larger than the maximum width in the main scanning direction of the sheet S that can be stacked in the internal tray 37). For example, the position sensors 60L and 60R output position signals to a controller 160 when the side fences 41L and 41R are arranged at the standby positions, and stop outputting position signals when the side fences 41L and 41R are arranged at positions different from the standby positions. The specific configurations of the position sensors 60L and 60R are not particularly limited, and for example, a mechanical sensor, an optical sensor, or a magnetic sensor can be adopted. The same applies to other sensors.

The crimp binder 42 (binder) and the staple binder 43 (binder) are arranged at a downstream end in the second conveyance direction of the sheet bundle Sb supported by the internal tray 37. The crimp binder 42 and the staple binder 43 are independently movable in the main scanning direction along the sheet bundle Sb supported by the internal tray 37. The crimp binder 42 and the staple binder 43 are independently rotatable around rotation shafts 55 and 57 extending in the thickness direction of the sheet S supported by the internal tray 37. The crimp binder 42 is, for example, a crimp binder that pressure-deforms the sheet bundle Sb and binds the sheet bundle Sb. The staple binder 43 is, for example, a staple binder that causes a binding needle to penetrate the sheet bundle Sb to bind the sheet bundle Sb. However, the binding processing apparatus 30 may include only one or both of the crimp binder 42 and the staple binder 43.

The crimp binder 42 is movable in the main scanning direction by a main scanning motor 47, a driving pulley 48a, a driven pulley 48b, and endless annular belts 49a and 49b. The main scanning motor 47 generates a driving force for moving the crimp binder 42 in the main scanning direction. The driving pulley 48a and the driven pulley 48b are rotatably supported by the binding case 31 respectively at positions separated from each other in the main scanning direction. The endless annular belt 49a is stretched around an output shaft of the main scanning motor 47 and the driving pulley 48a. The endless annular belt 49b is stretched around the driving pulley 48a and the driven pulley 48b. The crimp binder 42 is attached to the endless annular belt 49b.

The driving force of the main scanning motor 47 is transmitted to the driving pulley 48a through the endless annular belt 49a. The endless annular belt 49b circulates around the driving pulley 48a and the driven pulley 48b as the driving pulley 48a rotates. As a result, the crimp binder 42 attached to the endless annular belt 49b moves in the main scanning direction. The driving pulley 48a, the driven pulley 48b, and the endless annular belts 49a and 49b are an example of a driving force transmission mechanism that transmits the driving force of the main scanning motor 47 to the crimp binder 42. Here, the specific configuration of the driving force transmission mechanism is not limited to the above-described example.

The staple binder 43 is movable in the main scanning direction by a main scanning motor 50, a driving pulley 51a, a driven pulley 51b, and endless annular belts 52a and 52b. The main scanning motor 50 generates a driving force for moving the staple binder 43 in the main scanning direction. The driving pulley 51a and the driven pulley 51b are rotatably supported by the binding case 31 respectively at positions separated from each other in the main scanning direction. The endless annular belt 52a is stretched around an output shaft of the main scanning motor 50 and the driving pulley 51a. The endless annular belt 52b is stretched around the driving pulley 51a and the driven pulley 51b. The staple binder 43 is attached to the endless annular belt 52b.

The driving force of the main scanning motor 50 is transmitted to the driving pulley 51a through the endless annular belt 52a. The endless annular belt 52b circulates around the driving pulley 51a and the driven pulley 51b as the driving pulley 51a rotates. As a result, the staple binder 43 attached to the endless annular belt 52b moves in the main scanning direction. The driving pulley 51a, the driven pulley 51b, and the endless annular belts 52a and 52b are an example of a driving force transmission mechanism that transmits the driving force of the main scanning motor 50 to the staple binder 43. Here, the specific configuration of the driving force transmission mechanism is not limited to the above-described example.

The binding processing apparatus 30 includes position sensors 53 and 54. The position sensors 53 and 54 detect the positions of the crimp binder 42 and the staple binder 43 in the main scanning direction. For example, the position sensors 53 and 54 output a position signal to the controller 160 when the crimp binder 42 and the staple binder 43 are arranged at a predetermined position (home position) in the main scanning direction, and stop outputting the position signal when the crimp binder 42 and the staple binder 43 are arranged at a position different from the home position.

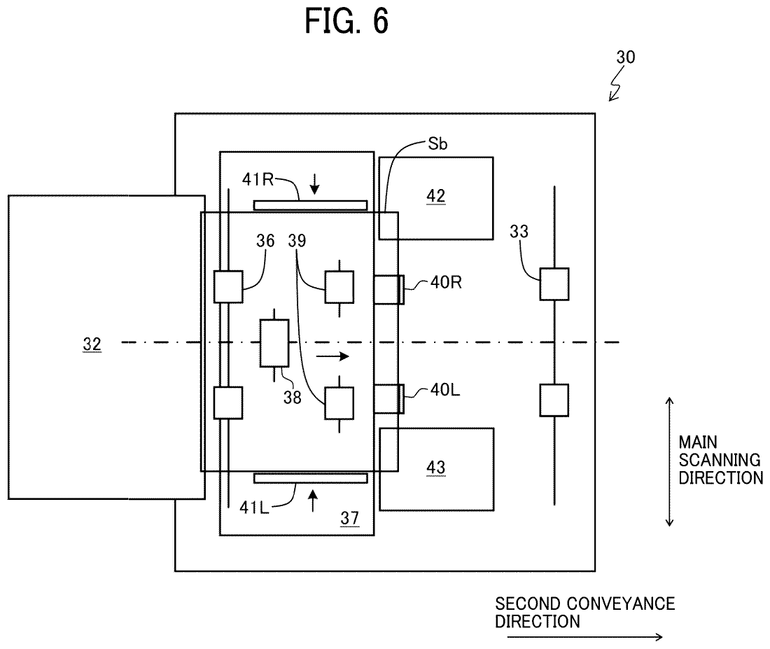

The crimp binder 42 is rotatably supported by the binding case 31 around the rotation shaft 55 extending in the thickness direction of the sheet S supported by the internal tray 37. The crimp binder 42 rotates between a parallel binding posture illustrated in FIG. 6 and an oblique binding posture illustrated in FIG. 3 by transmission of the driving force of a rotation motor 56 (see FIG. 13). Similarly, when the driving force of a rotation motor 58 (see FIG. 13) is transmitted, the staple binder 43 rotates about the rotation shaft 57 extending in the thickness direction of the sheet S supported by the internal tray 37.

### Basic Operation of Binding Processing Apparatus

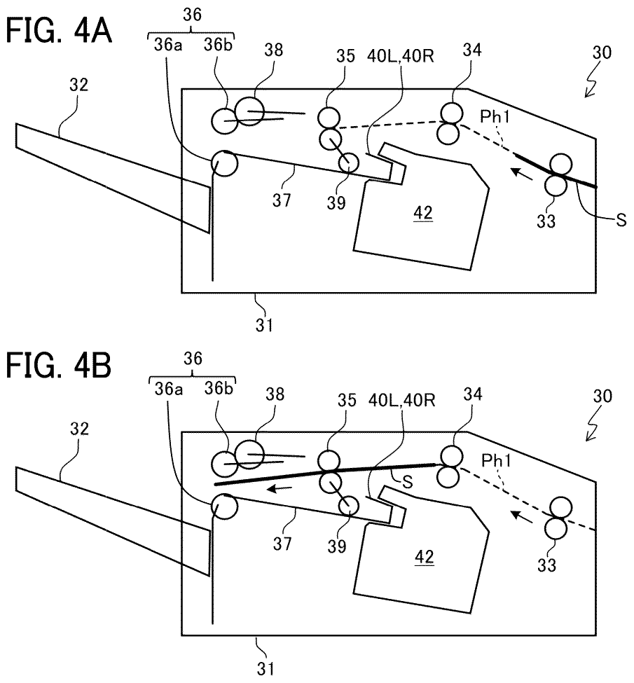

A description is given of the binding process, with reference to FIGS. 4A to 7B.

FIGS. 4A and 4B are diagrams each illustrating a state of the binding processing apparatus 30 until the sheet S reaches the conveyance roller pair 36.

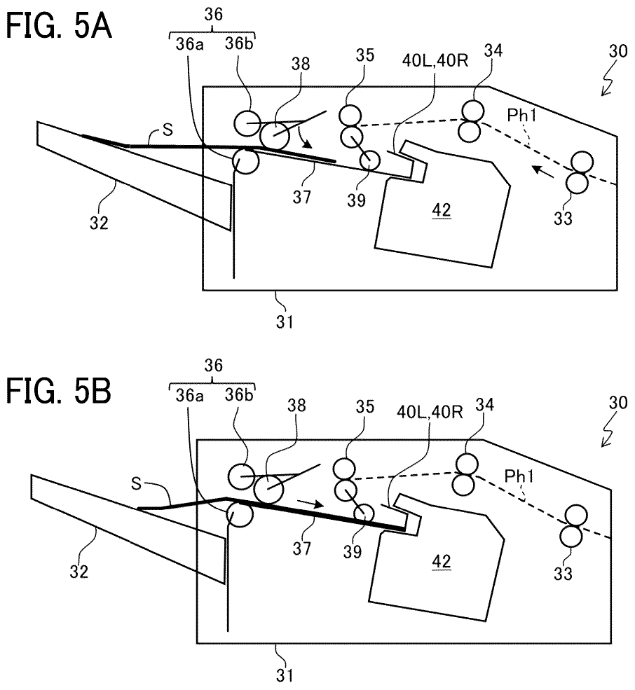

FIGS. 5A and 5B are diagrams each illustrating a state of the binding processing apparatus 30 performing the binding process.

FIG. 6 is a diagram illustrating the binding processing apparatus 30 in the state illustrated in FIG. 5B as viewed from the thickness direction of the sheet S.

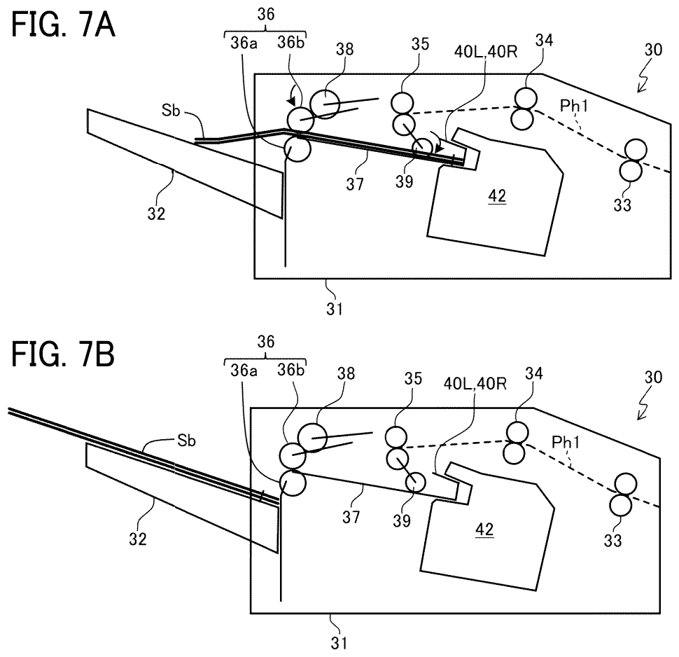

FIGS. 7A and 7B are diagrams illustrating the state of the binding processing apparatus 30 in a case where the sheet bundle Sb subjected to the binding process is ejected to the second ejection tray 32.

As illustrated in FIGS. 4A and 4B, the binding processing apparatus 30 rotates the conveyance roller pairs 33 to 35 forward to convey the sheet S supplied from the image forming device 115 along the conveyance path Ph1. At this time, in the conveyance roller pair 36, the driving roller 36a and the driven roller 36b are separated from each other.

As illustrated in FIGS. 5A and 5B, the binding processing apparatus 30 brings the tapping roller 38 into contact with the sheet S which has passed through the conveyance roller pair 35, and rotates the tapping roller 38 to accommodate the sheet S in the internal tray 37. As illustrated in FIG. 6, the downstream end of the sheet S stacked in the internal tray 37 in the second conveyance direction contacts the end fences 40L and 40R, and the position of the sheet S in the conveyance direction is aligned. The binding processing apparatus 30 moves the side fences 41L and 41R in the main scanning direction to align the position of the sheet S accommodated in the internal tray 37 in the main scanning direction (so-called jogging). The binding processing apparatus 30 forms the sheet bundle Sb on the internal tray 37 by repeating the processes illustrated in FIGS. 4A to 6.

As illustrated in FIG. 7A, the binding processing apparatus 30 causes the crimp binder 42 to face the binding position of the sheet bundle Sb in response to a predetermined number of sheets S being laminated on the internal tray 37. Then, the binding processing apparatus 30 performs the press-bonding binding of the sheet bundle Sb supported by the internal tray 37 by driving the crimp binder 42. As illustrated in FIG. 7B, the binding processing apparatus 30 causes the conveyance roller pair 36 to eject the sheet bundle Sb to the second ejection tray 32 by reversely rotating the conveyance motor.

### Description of Driving Mechanism of Conveyance Roller Pair and Return Roller

FIG. 8 is a diagram illustrating a state where the conveyance roller pair 35 is at the release position and the return roller 39 is at the conveyance position.

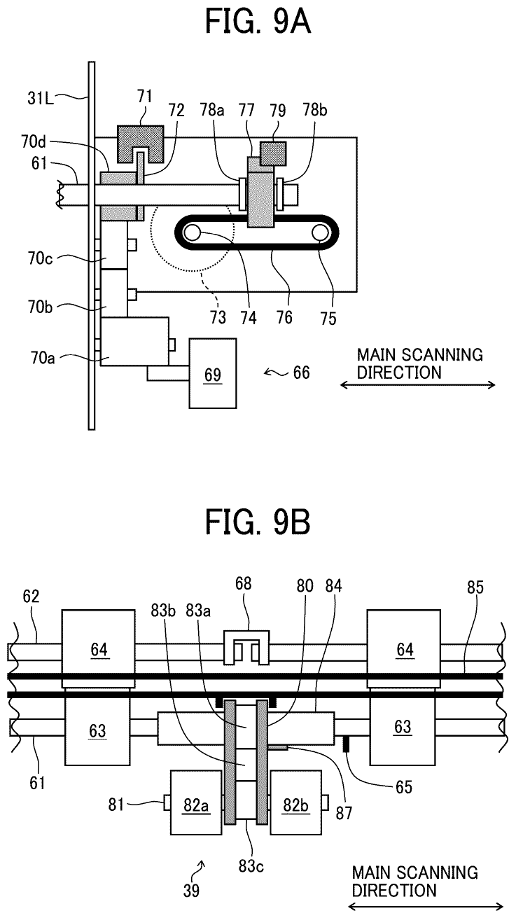

FIG. 9A is an enlarged view of a rotation driving mechanism 66.

FIG. 9B is an enlarged view of the return roller 39.

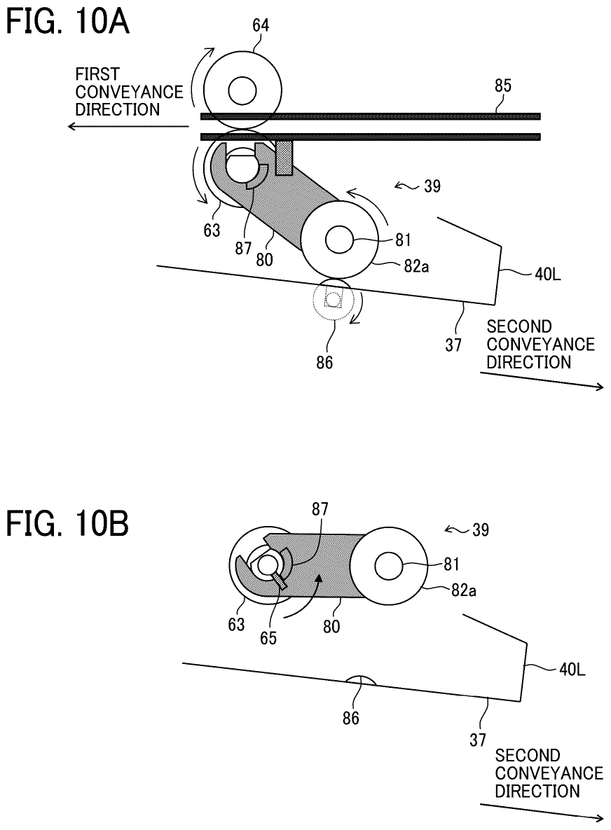

FIG. 10A is a diagram illustrating the return roller 39 at a conveyance position.

FIG. 10B is a diagram illustrating the return roller 39 at a retraction position.

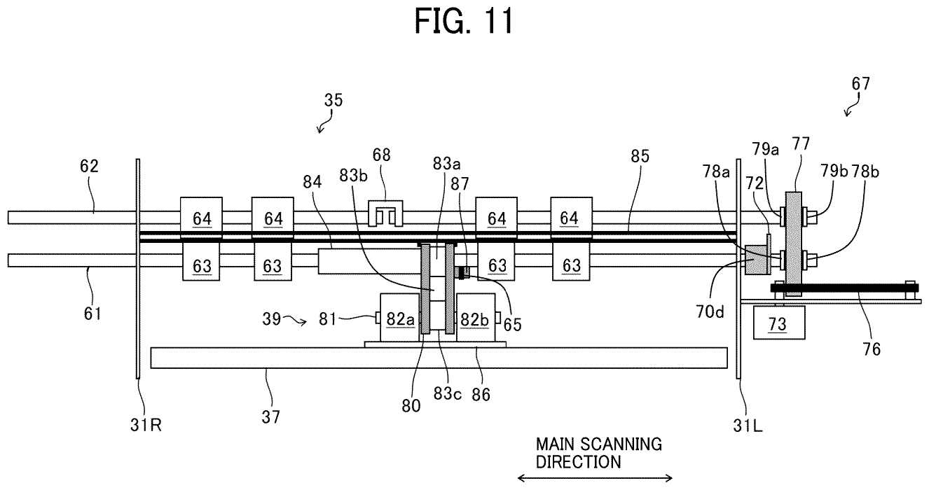

FIG. 11 is a diagram illustrating a state where the conveyance roller pair 35 is at an engagement position and the return roller 39 is at a conveyance position.

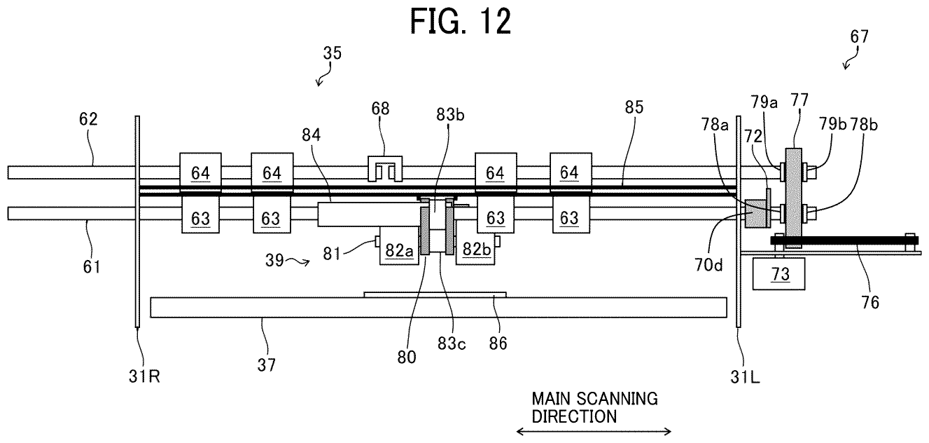

FIG. 12 is a diagram illustrating a state where the conveyance roller pair 35 is at an engagement position and the return roller 39 is at a conveyance position.

As illustrated in FIG. 8, the conveyance roller pair 35 and the return roller 39 are supported by a pair of frames 31L and 31R secured to the binding case 31. The pair of frames 31L and 31R is disposed on the opposite side across the conveyance path Ph1 and the internal tray 37 in the main scanning direction. The pair of frames 31L and 31R extends in a direction orthogonal to the main scanning direction. In other words, the sheet S and the sheet bundle Sb conveyed by the conveyance roller pair 35, the tapping roller 38, and the return roller 39 pass between the pair of frames 31L and 31R.

As illustrated in FIGS. 8, 9A, and 9B, conveyance roller pair 35 includes, for example, a drive shaft 61, a driven shaft 62, a plurality of driving rollers 63, a plurality of driven rollers 64, and a pin 65 (first engagement portion). The binding processing apparatus 30 includes the rotation driving mechanism 66 (rotation driver) and a slide driving mechanism 67 (slide driver). The rotation driving mechanism 66 and the slide driving mechanism 67 are an example of a driver that rotates with the conveyance roller pair 35 and the return roller 39 and moves the return roller 39 to a conveyance position where the return roller 39 contacts and conveys the sheet S or the sheet bundle Sb stacked in the internal tray 37 and a retraction position where the return roller 39 is retracted from the sheet S or the sheet bundle Sb stacked in the internal tray 37.

The rotation driving mechanism 66 rotates the conveyance roller pair 35 and the return roller 39 by a single driving source (rotation motor 69). In other words, the rotation driving mechanism 66 transmits the driving force of the rotation motor 69 to the conveyance roller pair 35 and the return roller 39. The slide driving mechanism 67 moves the conveyance roller pair 35 in the main scanning direction to shift the sheet S nipped by the conveyance roller pair 35 in the main scanning direction. The rotation driving mechanism 66 and the slide driving mechanism 67 combine movement and rotation of the conveyance roller pair 35 in the main scanning direction to move the return roller 39 to the conveyance position and the retraction position.

The drive shaft 61 and the driven shaft 62 extend in the main scanning direction. The drive shaft 61 and the driven shaft 62 are disposed on the opposite side across the conveyance path Ph1. The drive shaft 61 and the driven shaft 62 are rotatably supported by the frames 31L and 31R. In the example of FIG. 8, the driven shaft 62 is divided into right and left portions, and the center thereof is coupled by a coupling member 68. The drive shaft 61 and the driven shaft 62 rotate (spin) by transmission of the driving force of the rotation driving mechanism 66, and slide in the main scanning direction by transmission of the driving force of the slide driving mechanism 67.

The plurality of driving rollers 63 is externally fitted to the drive shaft 61 at positions separated in the main scanning direction. The driving roller 63 rotates integrally with the drive shaft 61. The plurality of driven rollers 64 is externally fitted to the driven shaft 62 at positions separated in the main scanning direction. The driven roller 64 rotates integrally with the driven shaft 62. The driving roller 63 and the driven roller 64 are disposed at positions facing each other across the conveyance path Ph1. In other words, the driving roller 63 and the driven roller 64 nip the sheet S on the conveyance path Ph1 and rotate, whereby the sheet S is conveyed in the first conveyance direction.

The pin 65 is provided on the drive shaft 61. More particularly, the pin 65 protrudes radially outward from the outer peripheral surface of the drive shaft 61 at one location in the circumferential direction of the drive shaft 61. The pin 65 is provided at a position that can be engaged with a protrusion 87 described below in the main scanning direction.

More particularly, the pin 65 is engaged with the protrusion 87 when the conveyance roller pair 35 is at the engagement position (FIGS. 11 and 12), and the engagement with the protrusion 87 is released when the conveyance roller pair 35 is at the release position (FIG. 8). The pin 65 rotates together with the drive shaft 61 and slides in the main scanning direction together with the drive shaft 61.

The rotation driving mechanism 66 rotates the conveyance roller pair 35 and the return roller 39. For example, as illustrated in FIG. 9A, the rotation driving mechanism 66 includes the rotation motor 69 and a plurality of gears 70a to 70d. The rotation motor 69 is a driving source that generates a driving force for rotating the conveyance roller pair 35 and the return roller 39. The gears 70a to 70f mesh with each other to transmit the driving force of the rotation motor 69 to the drive shaft 61. As a result, the drive shaft 61 and the driving roller 63 rotate counterclockwise in FIG. 10A. The driven roller 64 is rotated (driven) clockwise in FIG. 10A with the rotation of the driving roller 63 by contacting the driving roller 63 with the sheet S interposed therebetween. Here, the specific configuration of the rotation driving mechanism 66 is not limited to the above-described example.

The binding processing apparatus 30 includes a rotation sensor 71. The rotation sensor 71 detects that the conveyance roller pair 35 (more particularly, the drive shaft 61) has reached a predetermined position (referred to as a “home position”) in the circumferential direction in the circumferential direction of the drive shaft 61, and outputs a rotation signal indicating a detection result to the controller 160. The rotation sensor 71 outputs the rotation signal when the drive shaft 61 is at the home position, and stops outputting the rotation signal when the drive shaft 61 is at a position different from the home position.

The gear 70d that rotates integrally with the drive shaft 61 includes a feeler 72. The feeler 72 protrudes outward in the radial direction from the end surface of the gear 70d at one position in the circumferential direction of the gear 70d.

The feeler 72 is disposed at a position that is detected by the rotation sensor 71 when the drive shaft 61 is at the home position and is not detected by the rotation sensor 71 when the drive shaft 61 is at a position different from the home position. In other words, the rotation sensor 71 detects the feeler 72 once every time the drive shaft 61 makes one rotation. The rotation sensor 71 outputs a rotation signal when detecting the feeler 72, and stops outputting the rotation signal when not detecting the feeler 72. The home position detected by the rotation sensor 71 is a position where the pin 65 and the protrusion 87 are separated (that is, the engagement between the pin 65 and the protrusion 87 is released) in the circumferential direction.

The slide driving mechanism 67 slides the conveyance roller pair 35 in the main scanning direction. For example, as illustrated in FIGS. 8 and 9A, the slide driving mechanism 67 includes a slide motor 73, a driving pulley 74, a driven pulley 75, an endless annular belt 76, a slide member 77, and restricting members 78a, 78b, 79a, and 79b.

The slide motor 73 generates a driving force for sliding the conveyance roller pair 35 in the main scanning direction. The driving pulley 74 and the driven pulley 75 are rotatably supported by the binding case 31 respectively at positions separated from each other in the main scanning direction. The driving pulley 74 is attached to an output shaft of the slide motor 73. The endless annular belt 76 is wound around the driving pulley 74 and the driven pulley 75. When the slide motor 73 rotates, the endless annular belt 76 circulates around the driving pulley 74 and the driven pulley 75. The slide member 77 is secured to the endless annular belt 76. The restricting members 78a and 78b are secured to the drive shaft 61 with the slide member 77 interposed therebetween in the main scanning direction. The restricting members 79a and 79b are secured to the driven shaft 62 with the slide member 77 interposed therebetween in the main scanning direction.

When the endless annular belt 76 rotates in the first direction, the slide member 77 comes into contact with the restricting members 78a and 79a to slide the conveyance roller pair 35 to one side (left side in FIG. 8) in the main scanning direction. When the endless annular belt 76 rotates in the second direction opposite to the first direction, the slide member 77 comes into contact with the restricting members 78b and 79b to slide the conveyance roller pair 35 to the other side (right side in FIG. 8) in the main scanning direction. Here, the specific configuration of the slide driving mechanism 67 is not limited to the above-described example.

The binding processing apparatus 30 includes a position sensor 79. The position sensor 79 detects a position of the conveyance roller pair 35 (more particularly, the slide member 77) in the main scanning direction, and outputs a position signal indicating a detection result to the controller 160. The position sensor 79 outputs a position signal when the conveyance roller pair 35 is at an initial position, and stops outputting the position signal when the conveyance roller pair 35 is at a position different from the initial position.

When the driving force of the slide driving mechanism 67 is transmitted, the conveyance roller pair 35 moves in the main scanning direction between the initial position (release position) illustrated in FIG. 8 and the engagement position illustrated in FIGS. 11 and 12. The initial position is an example of a release position where the engagement between the pin 65 and the protrusion 87 is released (that is, the pin 65 and the protrusion 87 are displaced in the main scanning direction). The initial position is a position where the positions of the conveyance roller pairs 33 to 36 in the main scanning direction are aligned. The engagement position is a position where the pin 65 and the protrusion 87 can be engaged (that is, the pin 65 and the protrusion 87 face each other in the circumferential direction). The release position is not limited to the initial position as long as the engagement between the pin 65 and the protrusion 87 is released. In other words, a plurality of positions in the main scanning direction may be the release positions.

The return roller 39 rotates while contacting the upper face of the sheet S that has passed through the conveyance roller pair 35 in the first conveyance direction to convey the sheet S or the sheet bundle Sb in the second conveyance direction. The return roller 39 is disposed at a position facing the internal tray 37. As illustrated in FIGS. 8, 9B, 10A, and 10B, for example, the return roller 39 mainly includes an arm 80, a rotating shaft 81, driving rollers 82a and 82b, and a plurality of gears 83a to 83b. The binding processing apparatus 30 includes a bush 84, a restricting member 85, and a driven roller 86.

One end (rotation proximal end) of the arm 80 is rotatably supported by the drive shaft 61 via the bush 84. The bush 84 rotates together with the drive shaft 61 and slides in the main scanning direction together with the drive shaft 61. The bush 84 does not transmit the rotation of the drive shaft 61 to the arm 80, and does not transmit the slide of the drive shaft 61 in the main scanning direction to the arm 80. The arm 80 is restricted from sliding in the main scanning direction by the restricting members 85 secured to the frames 31L and 31R. In other words, the position of the arm 80 in the main scanning direction is secured.

The arm 80 rotatably supports the rotating shaft 81 at the other end (rotation tip). The rotating shaft 81 extends in the main scanning direction. The driving rollers 82a and 82b are attached to both ends of the rotating shaft 81. The arm 80 accommodates a plurality of gears 83a to 83c. The gear 83a is attached to the D-cut bush 84, for example.

As a result, the gear 83a rotates integrally with the bush 84 (drive shaft 61), and does not slide in the main scanning direction together with the bush 84 (drive shaft 61). The gear 83c is attached to the rotating shaft 81 and rotates integrally with the rotating shaft 81 and the driving rollers 82a and 82b. The gears 83a to 83c mesh with each other to transmit the rotation of the drive shaft 61 to the driving rollers 82a and 82b. The driving force of the rotation motor 69 is transmitted to the driving rollers 82a and 82b, and the driving rollers rotate counterclockwise in FIG. 10A. Here, the specific configuration of the mechanism for rotating the driving rollers 82a and 82b is not limited to the above-described example.

The driven roller 86 is supported by the internal tray 37 so as to be rotatable about a rotating shaft extending in the main scanning direction. A part of the outer peripheral surface of the driven roller 86 protrudes upward from the upper face of the internal tray 37. As illustrated in FIG. 10A, the driven roller 86 is disposed at a position facing the driving rollers 82a and 82b when the return roller 39 is at the conveyance position. The driven roller 86 contacts the driving rollers 82a and 82b (alternatively, the driving rollers 82a and 82b with the sheet S interposed therebetween), and rotates (is driven) clockwise in FIG. 10A with the rotation of the driving rollers 82a and 82b.

The protrusion 87 is provided on a side surface (surface facing the main scanning direction) of the arm 80.

The protrusion 87 protrudes in the main scanning direction from the side surface of the arm 80. The protrusion 87 is provided at a part in the circumferential direction. The protrusion 87 is disposed at a position not engaged with the pin 65 when the conveyance roller pair 35 is at the release position. The protrusion 87 is disposed at a position not engaged with the pin 65 when the conveyance roller pair 35 is at the engagement position and the home position. The protrusion 87 is engaged with the pin 65 as illustrated in FIG. 10B when the conveyance roller pair 35 is at the engagement position and the conveyance roller pair 35 rotates from the home position.

The return roller 39 is movable (more particularly, the arm 80 is rotatable) to the conveyance position illustrated in FIG. 10A and the retraction position illustrated in FIG. 10B. The initial position of the return roller 39 is the conveyance position. The return roller 39 moves from the conveyance position to the retraction position by transmission of the driving force of the rotation motor 69. When the transmission of the driving force of the rotation motor 69 is released, the return roller 39 moves from the retraction position to the conveyance position by its own weight (alternatively, the biasing force of the biasing portion).

The conveyance position is a position where the driving rollers 82a and 82b can come into contact with the driven roller 86 (alternatively, the sheet S or the sheet bundle Sb stacked in the internal tray 37). In other words, when the return roller 39 is at the conveyance position, the driving rollers 82a and 82b are rotated to convey the sheet S or the sheet bundle Sb stacked in the internal tray 37 in the second conveyance direction.

The retraction position is a position where the driving rollers 82a and 82b are retracted upward from the driven roller 86 (alternatively, the sheet S or the sheet bundle Sb stacked in the internal tray 37). In other words, when the return roller 39 is at the retraction position, even in a case where the driving rollers 82a and 82b rotate, the sheet S or the sheet bundle Sb stacked in the internal tray 37 is not conveyed. There may be a plurality of retraction positions according to the thickness of the sheet bundle Sb stacked in the internal tray 37.

As illustrated in FIG. 8, when the conveyance roller pair 35 is at the release position, since the pin 65 and the protrusion 87 are displaced in the main scanning direction, the pin 65 and the protrusion 87 are not engaged even in a case where the drive shaft 61 rotates from the home position. Therefore, the return roller 39 is maintained at the conveyance position. When the rotation motor 69 is rotated in this state, the conveyance roller pair 35 rotates in a direction of conveying the nipped sheet S in the first conveyance direction, and the return roller 39 rotates in a direction of conveying the sheet S or the sheet bundle Sb supported by the internal tray 37 in the second conveyance direction.

As illustrated in FIG. 11, when the conveyance roller pair 35 is slid from the release position to the engagement position, the pin 65 and the protrusion 87 face each other in the circumferential direction. However, when the conveyance roller pair 35 is at the home position, the pin 65 is not yet engaged with the protrusion 87. Therefore, the return roller 39 is maintained at the conveyance position. As illustrated in FIG. 12, when the conveyance roller pair 35 at the engagement position is rotated, the pin 65 is engaged with the protrusion 87, and the arm 80 rotates with the rotation of the drive shaft 61. As a result, the driving rollers 82a and 82b are retracted upward from the sheet S or the sheet bundle Sb supported by the internal tray 37. In other words, the return roller 39 moves to the retraction position.

When the conveyance roller pair 35 rotates to the home position while the return roller 39 is at the retraction position, the pin 65 and the protrusion 87 are separated from each other in the circumferential direction. As a result, as illustrated in FIG. 11, the return roller 39 returns from the retraction position to the conveyance position. Then, when the conveyance roller pair 35 is slid from the engagement position to the release position, the pin 65 and the protrusion 87 are displaced in the circumferential direction as illustrated in FIG. 8.

As illustrated in FIG. 2A, an opening 31A is formed in the binding case 31. More particularly, the opening 31A is provided on a side surface of the binding case 31 supporting the second ejection tray 32 and above the second ejection tray 32. The sheet S or the sheet bundle Sb conveyed by the conveyance roller pair 36 is ejected to the second ejection tray 32 through the opening 31A. The opening 31A is configured such that the sheet bundle Sb can be manually fed into the binding case 31 (more particularly, the internal tray 37 through a space between the separated conveyance roller pairs 36) from the outside.

### Hardware Configuration of Image Forming Apparatus

FIG. 13 is an example of a hardware configuration diagram of the image forming apparatus 1.

As illustrated in FIG. 13, the image forming apparatus 1 includes, for example, the controller 150 (control unit) that controls the operation of the main body of the image forming apparatus 1, and the controller 160 (control unit) that controls the operation of the binding processing apparatus 30. The controllers 150 and 160 cooperatively control the operation of the image forming apparatus 1.

The controllers 150 and 160 include, for example, central processing units (CPUs) 151 and 161 and memories 152 and 162. The memories 152 and 162 include, for example, a read only memory (ROM), a random access memory (RAM), a hard disk drive (HDD), or a combination of ROM, RAM and HDD. The controllers 150 and 160 implement a process to be described below by the CPUs 151 and 161 reading and executing program codes stored in the memories 152 and 162. Here, the specific configurations of the controllers 150 and 160 are not limited thereto, and may be implemented by hardware such as an application specific integrated circuit (ASIC) and a field-programmable gate array (FPGA).

The controller 150 controls operation of the components (for example, the sheet feed roller 197, the image forming device 115, the fixing device 120, the conveyance roller pairs 131 and 132, and the control panel 149) of the main body of the image forming apparatus 1 through an internal interface (IF) 153. The controller 160 controls operation of the components (for example, the conveyance roller pairs 33 to 36, the tapping roller 38, the return roller 39, the end fences 40L and 40R, the side fences 41L and 41R, the crimp binder 42, the staple binder 43, the position sensors 53, 54, 60L, 60R, and 79, the rotation sensor 71, and rotary encoders 47a, 50a, 56a, 58a, 59La, 59Ra, 69a, and 73a) of the binding processing apparatus 30 through an internal IF 163. Although merely main motors and sensors of the present disclosure are illustrated in FIG. 13, each component is driven by a motor (driving source), and an operation state (position, posture) is detected by sensors.

The control panel 149 includes an input unit (receiver) that receives inputs from a user (manual input) and a display (notifier) that notifies the user of information. The input unit (receiver) includes, for example, hard keys and a touch panel superimposed on the display. The control panel 149 acquires information from the operator through the input unit and provides information to the operator through the display. A specific example of the notifier is not limited to the display and may be a light-emitting diode (LED) lamp or a speaker.

The rotary encoders 47a, 50a, 56a, 58a, 59La, 59Ra, 69a, and 73a detect drive amounts (rotation amounts) of the main scanning motors 47 and 50, the rotation motors 56 and 58, the fence motors 59L and 59R, the rotation motor 69, and the slide motor 73. More particularly, the rotary encoders 47a, 50a, 56a, 58a, 59La, 59Ra, 69a, and 73a output pulse signals to the controller 160 along with the rotation of the main scanning motors 47 and 50, the rotation motors 56 and 58, fence motors 59L and 59R, the rotation motor 69, and the slide motor 73. The controller 160 can grasp the drive amounts of the main scanning motors 47 and 50, the rotation motors 56 and 58, the fence motors 59L and 59R, the rotation motor 69, and the slide motor 73 by counting the pulse signals output from the rotary encoders 47a, 50a, 56a, 58a, 59La, 59Ra, 69a, and 73a.

The controller 160 can grasp the current position of the crimp binder 42 in the main scanning direction by combining the detection results of the position sensor 53 and the rotary encoder 47a. In other words, the position sensor 53 and the rotary encoder 47a may be combined to serve as a position sensor that detects the position of the crimp binder 42 in the main scanning direction. Similarly, the controller 160 can grasp the current position of the staple binder 43 in the main scanning direction by combining the detection results of the position sensor 54 and the rotary encoder 50a. In other words, the position sensor 54 and the rotary encoder 50a may be combined to serve as a position sensor that detects the position of the staple binder 43 in the main scanning direction.

The controller 160 can grasp the current positions of the side fences 41L and 41R in the main scanning direction by combining the detection results of the position sensors 60L and 60R and the rotary encoders 59La and 59Ra. In other words, the position sensors 60L and 60R and the rotary encoders 59La and 59Ra may be combined to serve as position sensors that detect the positions of the side fences 41L and 41R in the main scanning direction.

The controller 160 can grasp the rotation amount of the conveyance roller pair 35 (more particularly, the pin 65) in the circumferential direction by combining the detection results of the rotation sensor 71 and the rotary encoder 69a. In other words, the rotation sensor 71 and the rotary encoder 69a may be combined to serve as a rotation sensor that detects the rotation amount of the conveyance roller pair 35 in the circumferential direction.

The controller 160 can grasp the current position of the conveyance roller pair 35 (more particularly, the pin 65) in the main scanning direction by combining the detection results of the position sensor 79 and the rotary encoder 73a. In other words, the position sensor 79 and the rotary encoder 73a may be combined to serve as a position sensor that detects the position of the conveyance roller pair 35 in the main scanning direction.

Further, the controllers 150 and 160 are communicably connected to each other through external IFs 154 and 164. The controllers 150 and 160 cooperatively control the operation of each component based on the information transmitted and received through the external IFs 154 and 164.

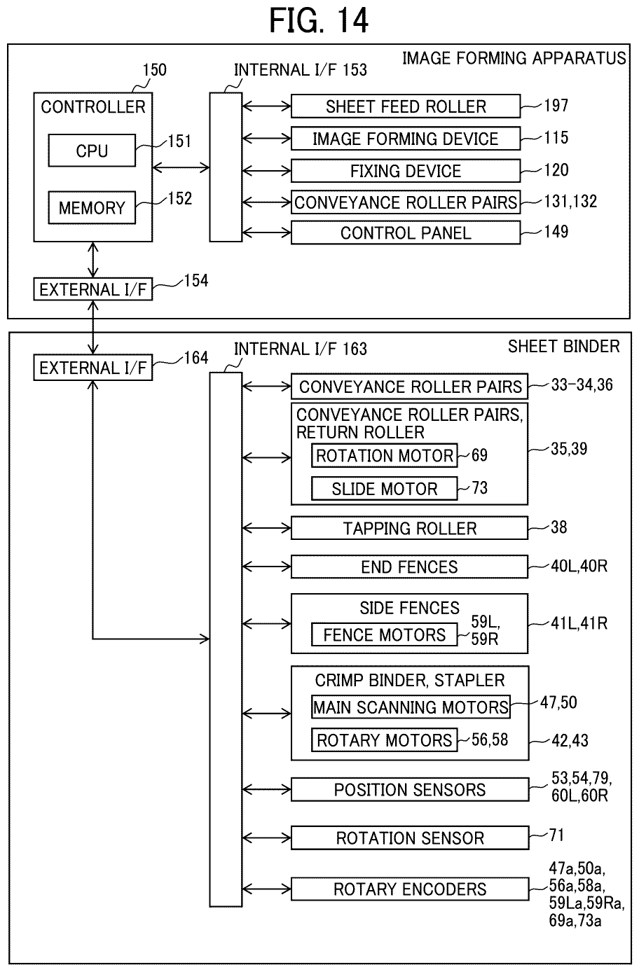

FIG. 14 is another example of the hardware configuration diagram of the image forming apparatus 1.

FIG. 14 is different from FIG. 13 in that the controller 160 of the binding processing apparatus 30 is omitted, and is the same as FIG. 13 in other aspects. The controller 150 illustrated in FIG. 14 controls the operation of the components of the main body of the image forming apparatus 1 through the internal IF 153, and controls the operation of the components of the binding processing apparatus 30 through the external IFs 154 and 164 and the internal IF 163. In other words, the binding processing apparatus 30 illustrated in FIG. 14 operates under the control of the controller 150 mounted on the main body of the image forming apparatus 1.

### Description of Process of Shifting Sheet by Conveyance Roller Pair

The binding processing apparatus 30 can realize a so-called “shift function” by shifting the sheet S supplied from the image forming device 115 in the main scanning direction by the conveyance roller pair 35 and then ejecting the sheet S to the second ejection tray 32.

First, in a case where a sensor detects that a rear end (an upstream end in the first conveyance direction) of the sheet S supplied from the image forming device 115 has passed through the conveyance roller pair 35, the controller 160 moves the conveyance roller pair 35 in the main scanning direction by the slide driving mechanism 67.

As a result, the sheet S nipped by the driving roller 63 and the driven roller 64 is shifted in the main scanning direction. At this time, it is assumed that the driving roller 36a and the driven roller 36b of the conveyance roller pair 36 are separated from each other. Then, the controller 160 causes the driving roller 36a and the driven roller 36b to contact each other, and causes the conveyance roller pairs 35 and 36 to eject the sheet S to the second ejection tray 32. The controller 160 changes the sliding amount of the conveyance roller pair 35 in units of sheets S (or in units of parts), whereby the sheets S are shifted in the main scanning direction and stacked in the second ejection tray 32.

### Manual Binding Control Process 1

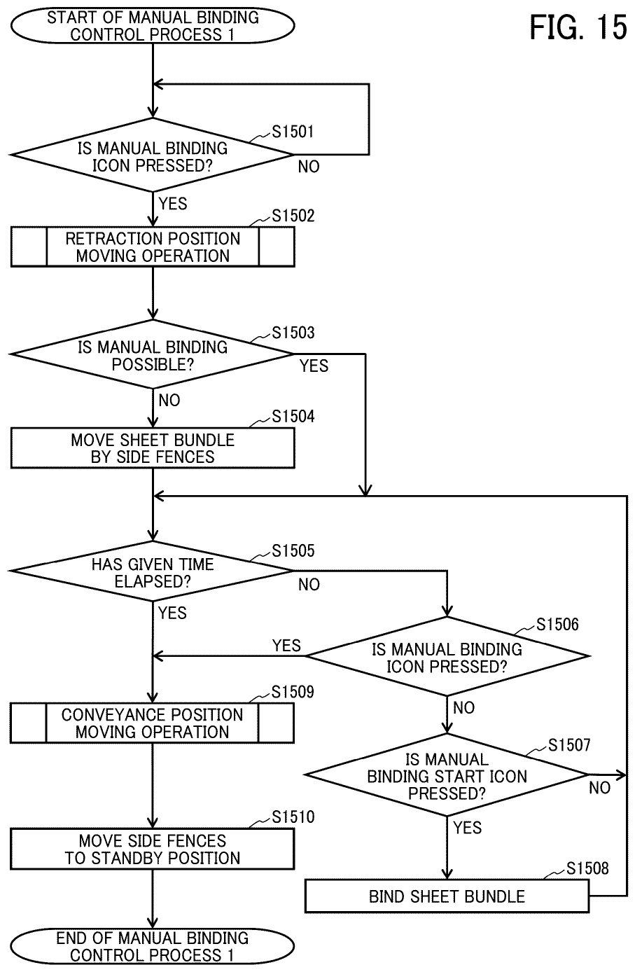

FIG. 15 is a flowchart of a manual binding control process 1.

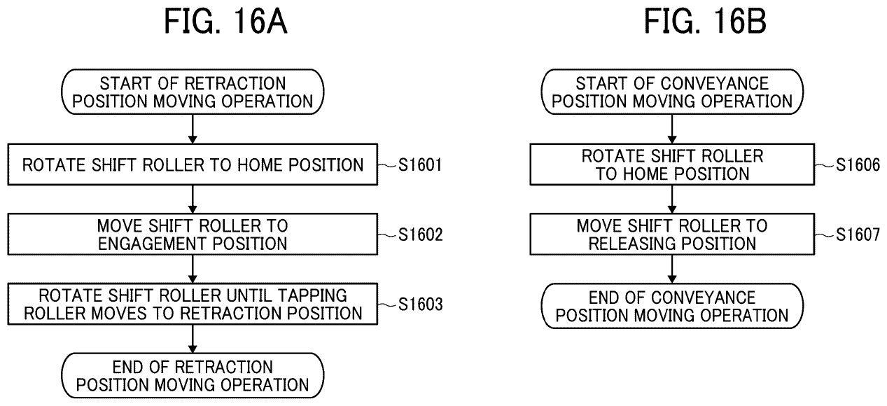

FIG. 16A is a flowchart of a retraction position movement process.

FIG. 16B is flowchart of a conveyance position movement process.

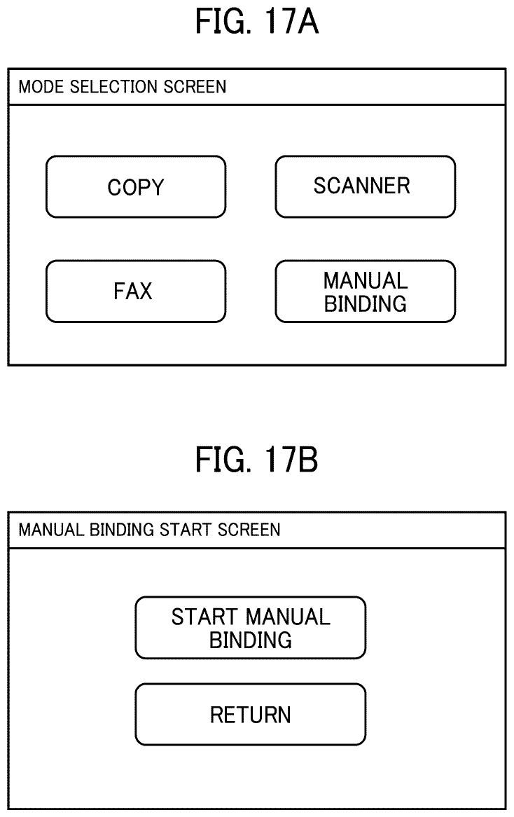

FIG. 17A is a screen example of a mode selection screen.

FIG. 17B is a screen example of a manual binding start screen.

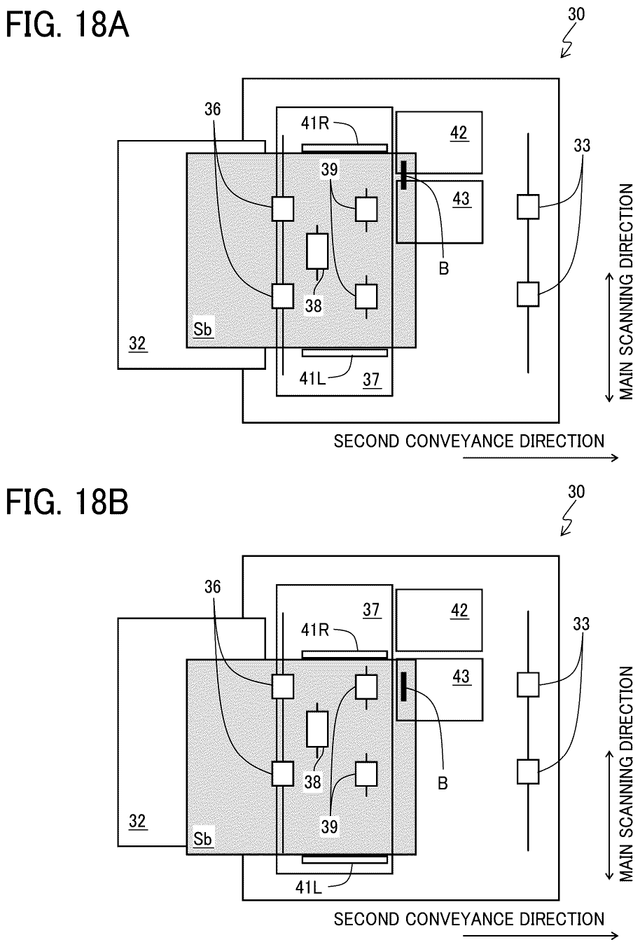

FIGS. 18A and 18B are diagrams illustrating the positions of the side fences 41L and 41R in the manual binding control process 1.

In the flowchart, the conveyance roller pair 35 is referred to as a “shift roller”.

The manual binding control process 1 is a process of binding the sheet bundle Sb manually inserted through the opening 31A when a print job is not executed in the image forming apparatus 1 (that is, the sheet S on which an image is formed is not supplied from the image forming unit 12 to the binding processing apparatus 30). At the start time of the manual binding control process 1, it is assumed that the conveyance roller pair 35 is at a release position, the conveyance roller pair 36 is separated, the return roller 39 is at a conveyance position, and the side fences 41L and 41R are at a standby position.

First, the controller 150 causes a mode selection screen illustrated in FIG. 17A to be displayed on the control panel 149. The mode selection screen is a screen for allowing the user to select process (mode) to be executed by the image forming apparatus 1. The mode selection screen includes [COPY] icon for forming an image read by the document reading device 102 on the sheet S by the image forming device 115, [SCANNER] icon for outputting (stacking in the memory 152, and transmitting to an external device) the image read by the document reading device 102, [FAX] icon for transmitting the image read by the document reading device 102 to an external device through a public telephone line, and [MANUAL BINDING] icon for binding the sheet bundle Sb manually fed through the opening 31A.

In a case where the [MANUAL BINDING] icon is pressed (step S1501: Yes), the controller 150 causes the user to select a binding method (for example, crimp binding and needle binding), a binding posture (for example, a parallel binding posture and an oblique binding posture), the size of the sheet bundle Sb (for example, A4 and B4), the thickness of the sheet bundle Sb (for example, the type and number of sheets S), and a binding position B, for example, through the selection screen. The controller 150 transmits binding information including various types of information selected by the user to the controller 160. The information included in the binding information may be set by default instead of being selected by the user. Pressing of the [MANUAL BINDING] icon is an example of inputting a manual binding instruction.

In a case where the binding information is received from the controller 150, the controller 160 executes a retraction position movement process illustrated in FIG. 16A (step S1502). First, the controller 160 rotates the rotation motor 69 to rotate the conveyance roller pair 35 to the home position (step S1601). Then, the controller 160 rotates the slide motor 73 to slide the conveyance roller pair 35 to the engagement position (step S1602). The controller 160 moves the return roller 39 to the retraction position by rotating the rotation motor 69 (step S1603). As a result, the user can manually feed the sheet bundle Sb into the internal tray 37 through the opening 31A.

Referring back to FIG. 15, the controller 160 determines whether the binding position B of the manually fed sheet bundle Sb can be bound based on the binding information received from the controller 150 (step S1503). For example, as illustrated in FIG. 18A, there is a case where the staple binder 43 cannot bind the binding position B at the back corner of the sheet bundle Sb due to the interference of the crimp binder 42. Therefore, in a case where it is determined that the binding position B is not bound (No in step S1503), the controller 160 rotates the fence motors 59L and 59R to move the sheet bundle Sb manually fed to the internal tray 37 in the main scanning direction by the side fences 41L and 41R (step S1504).

In other words, the controller 160 moves the sheet bundle Sb in the main scanning direction by the side fences 41L and 41R in a state where the return roller 39 is located at the retraction position. As a result, as illustrated in FIG. 18B, the staple binder 43 can face the binding position B. The processes in steps S1503 to S1504 are not limited to the manual binding process, and can also be applied to the case of binding with the sheet bundle Sb supplied from the image forming device 115. On the other hand, when it is determined that the binding position B can be bound (YES in step S1503), the controller 160 skips the process of step S1504.

The processes in steps S1502 to S1503 may be executed before the sheet bundle Sb is manually fed (for example, the retraction position movement process in FIG. 16A). In other words, the controller 160 may determine whether the binding position B of the sheet bundle Sb can be bound based on the combination of the size of the sheet bundle Sb and the binding position B indicated by the binding information. In a case where it is determined that the binding position B is not bound, the controller 160 may move the side fences 41L and 41R in advance in the main scanning direction so that the sheet bundle Sb is manually fed at the binding possible position. The user may manually feed the sheet bundle Sb between the side fences 41L and 41R whose positions have been adjusted.

After the binding information is transmitted to the controller 160, the controller 150 causes a manual binding start screen illustrated in FIG. 17B to be displayed on the control panel 149. The manual binding start screen includes, for example, [START MANUAL BINDING] icon and [RETURN] icon. In a case where the [START MANUAL BINDING] icon is pressed, the controller 150 transmits a manual binding start instruction to the controller 160. On the other hand, in a case where the [RETURN] icon is pressed, the controller 150 causes the mode selection screen to be displayed on the control panel 149 again. In a case where the [MANUAL BINDING] icon is pressed again, the controller 150 transmits a manual binding stop instruction to the controller 160.

In other words, in a case where the manual binding is executed, the user may press the [MANUAL BINDING] icon, then manually feed the sheet bundle Sb through the opening 31A, and press the [START MANUAL BINDING] icon. On the other hand, in a case where the manual binding is stopped, the user removes the sheet bundle Sb that has been manually fed, and presses the [RETURN] icon and the [MANUAL BINDING] icon. Then, the controller 160 waits for execution of the processes of step S1508 and subsequent steps until a predetermined time elapses (step S1505) or a manual binding start instruction and a manual binding stop instruction are received from the controller 150 (steps S1506 and S1507).

In a case where a manual binding start instruction is received from the controller 150 before a predetermined time elapses after the return roller 39 is moved to the retraction position (NO in steps S1505 and S1506, YES in step S1507), the controller 160 binds the binding position B of the sheet bundle Sb manually fed into the internal tray 37 according to the binding information (step S1508). In other words, the controller 160 rotates the main scanning motors 47 and 50 and the rotation motors 56 and 58 to cause the crimp binder 42 or the staple binder 43 to face the binding position B. The controller 160 causes the crimp binder 42 or the staple binder 43 to bind the binding position B.

In a case where a predetermined time has elapsed since the binding of the sheet bundle Sb (from step S1508 to YES in step S1505), the controller 160 executes the conveyance position movement process illustrated in FIG. 16B (step S1509). The predetermined time here is set to a time necessary for pulling out the bound sheet bundle Sb through the opening 31A by the user. In a case where the notification of execution of step S1508 is received from the controller 160, the controller 150 may notify that the sheet bundle Sb is to be pulled out through the control panel 149.

The controller 160 rotates the rotation motor 69 to rotate the conveyance roller pair 35 to the home position (step S1606). As a result, the return roller 39 moves to the conveyance position. Then, the controller 160 rotates the slide motor 73 to slide the conveyance roller pair 35 to the release position (step S1607). Then, referring back to FIG. 15, the controller 160 rotates the fence motors 59L and 59R to move the side fences 41L and 41R to the standby positions (step S1510).

In a case where a manual binding stop instruction is received from the controller 150 before a predetermined time elapses after the return roller 39 is moved to the retraction position (NO in step S1505 and YES in step S1506), the controller 160 executes the processes of steps S1509 to S1510 without executing the process of step S1508. In a case where the predetermined time has elapsed since the return roller 39 is moved to the retraction position (YES in step S1505), the controller 160 executes the processes of steps S1509 to S1510 without executing the process of step S1508. The predetermined time here is set to a time during which it can be determined that the manual binding is not executed although the user presses the [MANUAL BINDING] icon.

### Manual Binding Control Process 2

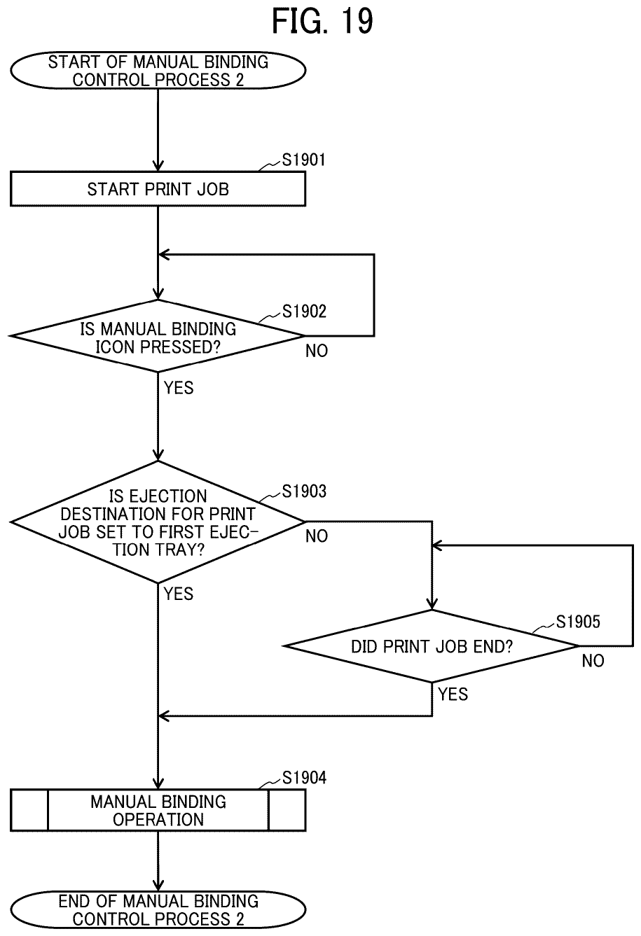

FIG. 19 is a flowchart of a manual binding control process 2.

The manual binding control process 2 is a process performed in a case where the [MANUAL BINDING] icon is pressed when a print job is being executed in the image forming apparatus 1. The state of each unit at the start of the manual binding control process 2 is common to the state of each unit of the manual binding control process 1. Detailed description of points in common with the manual binding control process 1 will be omitted, and differences will be mainly described.

The print job is a process of forming an image on the sheet S by the image forming device 115 and ejecting the sheet S to the first ejection tray 135 or the second ejection tray 32. The controller 150 starts the print job, for example, in a case where the [COPY] icon is pressed or in a case where a print instruction is received from an external device (step S1901). The controller 150 acquires image data to be formed on the sheet S, the size of the sheet S, the number of sheets S on which an image is to be formed, and an ejection destination (the first ejection tray 135 and the second ejection tray 32) of the sheet S on which an image is formed, from the control panel 149 or an external device, and executes a print job.

In a case where the [MANUAL BINDING] icon is pressed during the execution of the print job (YES in step S1902), the controller 150 determines the ejection destination of the print job (step S1903). The first ejection tray 135 is an ejection tray that is not used when the manual binding process (steps S1502 to S1510 in FIG. 15) is executed. On the other hand, the second ejection tray 32 is an ejection tray used when the manual binding process is executed.

In a case where it is determined that the ejection destination of the print job is the first ejection tray 135 (YES in step S1903), the controller 150 instructs the controller 160 to execute the manual binding process in parallel with the print job (step S1904). On the other hand, in a case where it is determined that the ejection destination of the print job is the second ejection tray 32 (NO in step S1903), the controller 150 causes the controller 160 to wait for execution of the manual binding process until the print job ends (NO in step S1905). After the print job is finished (YES in step S1905), the controller 150 instructs the controller 160 to execute the manual binding process (step S1904).

### Manual Binding Control Process 3

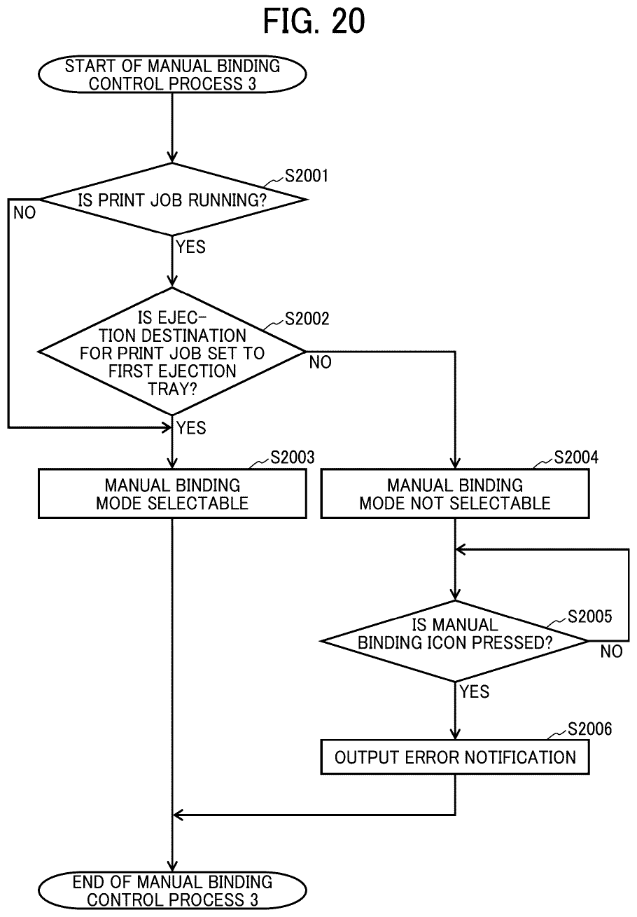

FIG. 20 is a flowchart of a manual binding control process 3.

The manual binding control process 3 is a process performed in a case where the [MANUAL BINDING] icon is pressed when a print job is being executed in the image forming apparatus 1. The state of each unit at the start of the manual binding control process 3 is common to the state of each unit of the manual binding control process 1. Detailed description of points in common with the manual binding control processes 1 and 2 will be omitted, and differences will be mainly described.

First, the controller 150 determines whether a print job is being executed (step S2001) and an ejection destination of the print job being executed (step S2002).

In a case where the controller 150 determines that the ejection destination of the print job being executed is the first ejection tray 135 (YES in step S2001 and YES in step S2002), the controller 150 activates the [MANUAL BINDING] icon on the mode selection screen (pressable state) (step S2003). In a case where it is determined that the print job is not being executed (NO in step S2001), the controller 150 skips the process of step S2002 and executes the process of step S2003. In a case where the activated [MANUAL BINDING] icon is pressed, the controller 150 instructs the controller 160 to execute the manual binding process.

On the other hand, in a case where the controller 150 determines that the ejection destination of the print job being executed is the second ejection tray 32 (YES in step S2001 and NO in step S2002), the controller 150 deactivates the [MANUAL BINDING] icon on the mode selection screen (unpressable state) (step S2004). In a case where the deactivated [MANUAL BINDING] icon is pressed (YES in step S2005), the controller 150 notifies the user of an error (that the manual binding process cannot be executed) through the control panel 149 (step S2006).

### Operation and Effect of First Embodiment

According to the first embodiment, the return roller 39 can be moved to the conveyance position and the retraction position using the rotation motor 69 that rotates the conveyance roller pair 35 and the slide motor 73 that slides the conveyance roller pair 35. In this manner, by omitting a dedicated driving source for moving the return roller 39, downsizing and cost reduction of the binding processing apparatus can be achieved.

According to the first embodiment, before the sheet bundle Sb supported by the internal tray 37 is moved in the main scanning direction by the side fences 41L and 41R, the return roller 39 is moved to the retraction position. As a result, the return roller 39 can be prevented from coming into contact with the sheet bundle Sb moving in the main scanning direction and damaging the sheet bundle Sb, and a decrease in accuracy of alignment in the main scanning direction can be prevented.

According to the first embodiment, in a case where a manual binding instruction is input to the control panel 149, by moving the return roller 39 to the retraction position, damage to the sheet bundle Sb manually fed into the internal tray 37 through the opening 31A can be prevented, and a decrease in accuracy of alignment in the second conveyance direction can be prevented.

According to the first embodiment, in a case where a print job is input during the execution of the manual binding process, the execution of the print job is made to stand by until the manual binding process ends (that is, the manually fed sheet bundle Sb is ejected through the opening 31A). As a result, this configuration can prevent occurrence of a paper jam due to interference between the sheet bundle Sb to be subjected to the manual binding process and the sheet S ejected in the print job.

### Second Embodiment

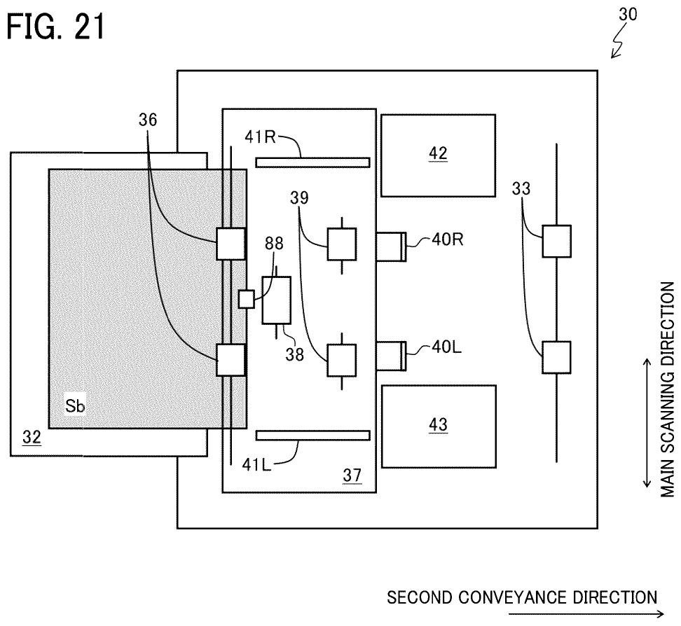

FIG. 21 is a diagram of the binding processing apparatus 30 according to a second embodiment as viewed from a thickness direction of the sheet S.

Detailed description of the common features with the first embodiment will be omitted, and the description will focus on the differences. The binding processing apparatus 30 according to the second embodiment is different from the first embodiment in that a sheet sensor 88 is provided, and is common to the first embodiment in other points.

The sheet sensor 88 is installed at a position where the sheet bundle Sb that is manually fed through the opening 31A and stacked in the internal tray 37 can be detected. In a case where the sheet bundle Sb is detected, the sheet sensor 88 outputs a detection signal to the controller 160. In a case where the sheet bundle Sb is not detected, the sheet sensor 88 stops outputting the detection signal.

### Manual Binding Control Process 4

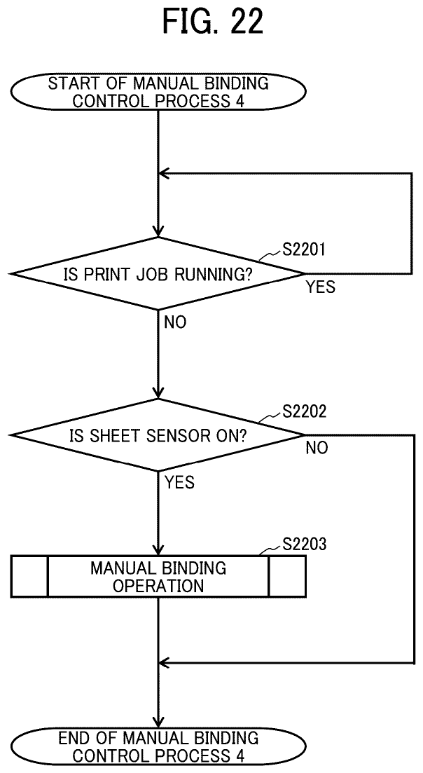

FIG. 22 is a flowchart of a manual binding control process 4.

The manual binding control process 4 is a process of binding the sheet bundle Sb manually fed through the opening 31A when a print job is not executed in the image forming apparatus 1. The state of each unit at the start of the manual binding control process 4 is common to the state of each unit of the manual binding control process 1. Detailed description of points in common with the manual binding control processes 1 to 3 will be omitted, and differences will be mainly described.

First, the controller 150 transmits a start notification to the controller 160 at the start of the print job, and transmits an end notification to the controller 160 at the end of the print job. In other words, the controller 160 can grasp whether the controller 150 is executing a print job. While the controller 150 is executing the print job (that is, from the reception of the start notification to the reception of the end notification) (NO in step S2201), the controller 160 waits for the execution of the processes of step S2202 and subsequent steps.

On the other hand, in a case where the controller 150 is not executing a print job (NO in step S2201), the controller 160 determines whether a detection signal is output from the sheet sensor 88 (sheet sensor ON) (step S2202). In a case where the detection signal is output from the sheet sensor 88 (YES in step S2202), the controller 160 executes the manual binding process (step S2203). On the other hand, in a case where the detection signal is not output from the sheet sensor 88 (NO in step S2202), the controller 160 skips step S2203.

### Manual Binding Control Process 5

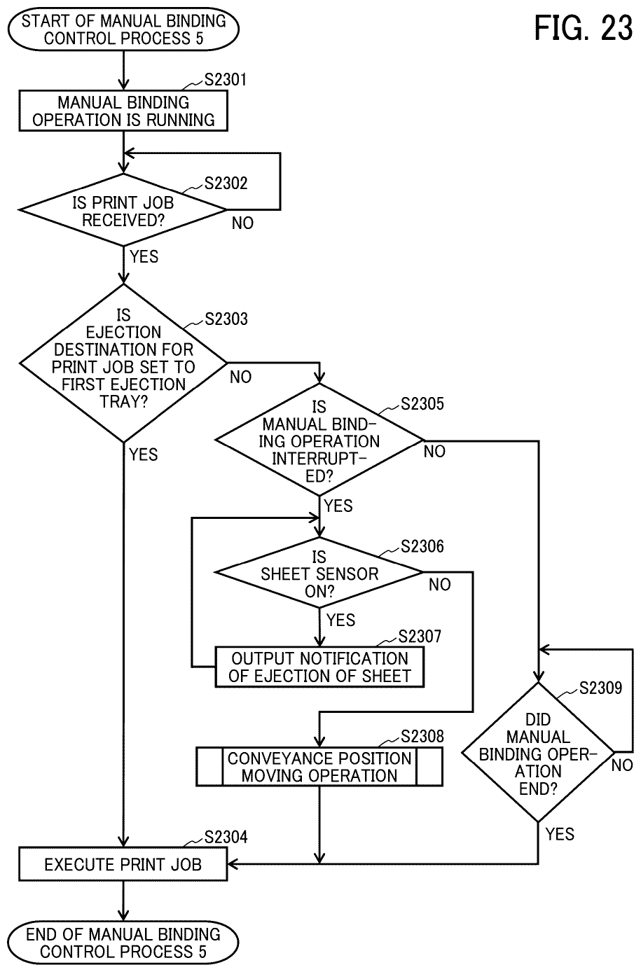

FIG. 23 is a flowchart of a manual binding control process 5.

The manual binding control process 5 is a process in a case where an instruction to start a print job is given during the execution of the manual binding process. It is assumed that it is on standby until any of steps S1505 to S1507 is established at the start of the manual binding control process 5. Detailed description of points in common with the manual binding control processes 1 to 4 will be omitted, and differences will be mainly described.

First, the controller 160 transmits a start notification to the controller 150 at the start of the manual binding process, and transmits an end notification to the controller 150 at the end of the manual binding process. In other words, the controller 150 can grasp whether the controller 160 is executing the manual binding process. In a case where a print job start instruction is acquired during the execution of the manual binding process (that is, from the reception of the start notification to the reception of the end notification) (from step S2301 to YES in step S2302), the controller 150 determines the ejection destination of the print job (step S2303).

In a case where the controller 150 determines that the ejection destination of the print job is the first ejection tray 135 (YES in step S2303), the instructed print job is executed in parallel with the execution of the manual binding process by the controller 160 (step S2304). On the other hand, in a case where it is determined that the ejection destination of the print job is the second ejection tray 32 (NO in step S2303), the controller 150 causes the user to select whether or not to end (interrupt) the manual binding process in the middle through the control panel 149 (step S2305).

In a case where the user selects the end in the middle of the manual binding process through the control panel 149 (YES in step S2305), the controller 150 inquires of the controller 160 whether a detection signal is output from the sheet sensor 88 (YES in step S2306). In a case where the detection signal is output from the sheet sensor 88, the controller 150 notifies the user of removal of the sheet bundle Sb manually fed through the opening 31A, through the control panel 149 (step S2307).

In a case where the detection signal is not output from the sheet sensor 88 (NO in step S2306), the controller 150 causes the controller 160 to execute the conveyance position movement process illustrated in FIG. 16B (step S2308), and then executes the print job (step S2304).

In a case where the user does not select the end in the middle of the manual binding process through the control panel 149 (NO in step S2305), the controller 150 executes the print job after receiving an end notification of the manual binding process from the controller 150 (from YES in step S2309 to step S2304). In other words, the controller 150 waits for execution of the print job (step S2304) until the sheet bundle Sb bound by the manual binding process is ejected through the opening 31A (NO in step S2309). As another example, in a case where the controller 150 determines that the ejection destination of the print job is the second discharge tray 32 and the user does not select the end in the middle of the manual binding process through the control panel 149 (NO in step S2303 and NO in step S2305), the controller 150 may change the discharge destination of the print job to the first discharge tray 135 and execute the print job.

### Operation and Effect of Second Embodiment

According to the second embodiment, providing the sheet sensor 88 can omit the trouble of pressing the [MANUAL BINDING] icon by the user on the mode selection screen. As a result, the work load of the user for executing the manual binding process can be reduced.

### Third Embodiment

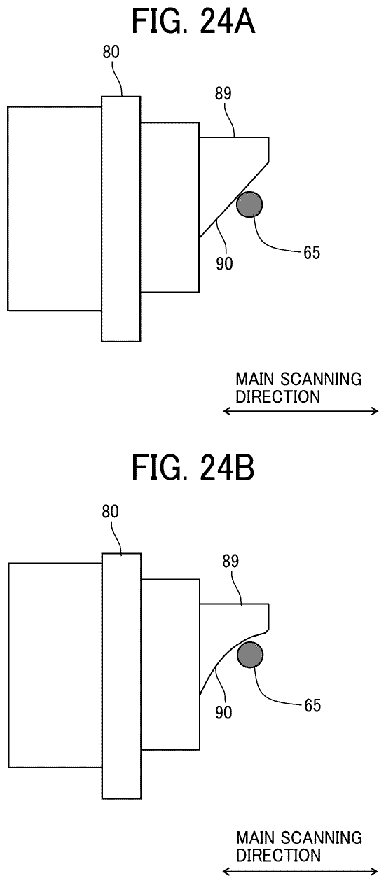

FIGS. 24A and 24B are views illustrating a shape of the protrusion 89 according to a third embodiment.

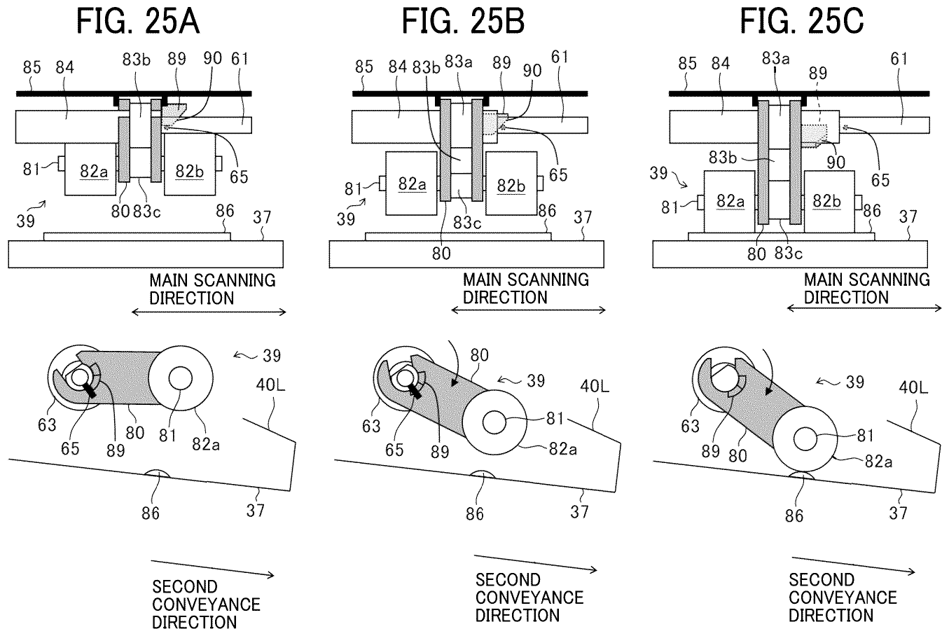

FIGS. 25A to 25C are views illustrating a state of the return roller 39 when the pin 65 is moved in the main scanning direction.

Detailed description of the common features with the first embodiment will be omitted, and the description will focus on the differences. The binding processing apparatus 30 according to the third embodiment is different from the first embodiment in the shape of the protrusion 89, and is common to the first embodiment in the other points.

As illustrated in FIGS. 24A and 24B, the protrusion 89 according to the third embodiment has an inclined surface 90 on the outer peripheral surface (surface that can come into contact with the pin 65). More particularly, the inclined surface 90 is formed such that the protrusion 89 is tapered toward the protruding end in the main scanning direction. The inclined surface 90 is formed at a position where the return roller 39 can come into contact with the pin 65 when the return roller 39 is at the retraction position in the circumferential direction. The inclined surface 90 may be a flat surface as illustrated in FIG. 24A or a curved surface as illustrated in FIG. 24B.

In the binding processing apparatus 30 according to the third embodiment, when the conveyance roller pair 35 is slid in the main scanning direction from the state where the conveyance roller pair 35 is at the engagement position and the return roller 39 is at the retraction position (FIG. 25A) toward the release position, the pin 65 moves in the main scanning direction along the inclined surface 90. As a result, as illustrated in FIGS. 25B and 25C, the return roller 39 (arm 80) gently moves (rotates) from the retraction position to the conveyance position.

### Operation and Effect of Third Embodiment

According to the third embodiment, since the return roller 39 gently moves from the retraction position to the conveyance position along with the movement of the pin 65 in the main scanning direction, this configuration can mitigate impact and noise when the return roller 39 returns to the conveyance position. As a result, in the conveyance position movement process illustrated in FIG. 16B, the process of rotating the conveyance roller pair 35 to the home position (step S1606) can be omitted. As a result, productivity of the binding processing apparatus 30 is enhanced.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Each process described above may be realized by, for example, a program. In other words, the CPU 151 or the CPU 161 may execute a program stored in the memory 152 or the memory 162 to implement each of the above-described processes. The program is not limited to a single program, and may be an aggregate of a plurality of programs. The program is not limited to being executed by one of the CPUs 151 and 161, and may be shared and executed by the CPUs 151 and 161. The program may be written in, for example, a storage device or a storage medium and distributed with the storage device or the storage medium, or may be distributed through, for example, an electric communication line.

Aspects of the present disclosure are, for example, as follows.

### Aspect 1

In Aspect 1, a medium processing apparatus includes a first conveyor, a second conveyor, a stacker, a binder, and a driver. The first conveyor nips a medium and rotates to convey the medium in a first conveyance direction. The second conveyor rotates while contacting an upper face of the medium that has passed through the first conveyor to convey the medium in a second conveyance direction different from the first conveyance direction. The stacker stacks the medium conveyed by the second conveyor. The binder binds a plurality of the media stacked on the stacker. The driver rotates the first conveyor and the second conveyor and moves the second conveyor to a conveyance position where the second conveyor contacts the medium stacked on the stacker and conveys the medium and a retraction position where the second conveyor retracts from the medium stacked on the stacker.

### Aspect 2

In Aspect 2, in the medium processing apparatus of Aspect 1, the driver includes a rotation driver and a slide driver. The rotation driver rotates the first conveyor and the second conveyor. The slide driver slides the first conveyor to an engagement position where the second conveyor is movable to the retraction position and a release position where the second conveyor is maintained at the conveyance position in a main scanning direction orthogonal to the first conveyance direction and the second conveyance direction.

### Aspect 3

In Aspect 3, in the medium processing apparatus of Aspect 2, the first conveyor includes a first engagement portion provided on a drive shaft that rotates by transmission of a driving force of the rotation driver. The second conveyor includes an arm, a roller, and a second engagement portion. The arm is rotatably supported by the drive shaft. The roller is supported by a distal end of the arm and rotates by transmission of a driving force of the rotation driver. The second engagement portion is engaged with the first engagement portion when the first conveyor is at the engagement position and is released from the first engagement portion when the first conveyor is at the release position. When the first conveyor is at the engagement position, by rotating the drive shaft by transmission of the driving force of the rotation driver, the arm rotates to the conveyance position where the roller is brought into contact with the medium stacked on the stacker, and the retraction position where the roller is retracted from the medium stacked on the stacker.

### Aspect 4

In Aspect 4, the medium processing apparatus of any one of Aspects 1 to 3 further includes a main scanning direction aligner that aligns positions of the plurality of the media stacked on the stacker in a main scanning direction orthogonal to the first conveyance direction and the second conveyance direction, in which the main scanning direction aligner moves the medium stacked on the stacker in the main scanning direction in a state where the second conveyor is located at the retraction position.

### Aspect 5

In Aspect 5, the medium processing apparatus of any one of Aspects 1 to 4 further includes an input unit (receiver), an opening, and a controller. The input unit (receiver) receives an input from a user (manual input). The opening is an opening through which a plurality of the media is manually fed toward the stacker. The controller controls the driver and the binder. In a case where a manual binding instruction is input to the input unit, the controller moves the second conveyor from the conveyance position to the retraction position, and causes the binder to bind the plurality of the media manually fed through the opening.

### Aspect 6

In Aspect 6, an image forming system includes an image forming apparatus that forms an image on a medium, and the medium processing apparatus of any one of Aspects 1 to 5 that processes the medium supplied from the image forming apparatus.

### Aspect 7

In Aspect 7, the image forming system of Aspect 6 further includes a detection unit, an opening, and a controller. The detection unit detects the medium stacked on the stacker. The opening is an opening through which a plurality of the media is manually fed toward the stacker. The controller controls the driver and the binder. In a case where the detection unit detects the medium when the medium is not supplied from the image forming apparatus, the controller moves the second conveyor from the conveyance position to the retraction position, and causes the binder to bind the plurality of the media manually fed through the opening.

### Aspect 8

In Aspect 8, an image forming system includes an image forming apparatus, a first conveyor, a second conveyor, a stacker, a binder, a driver, an input unit (receiver), an opening, and a controller. The image forming apparatus forms an image on a medium. The first conveyor nips the medium supplied from the image forming apparatus and rotates to convey the medium in a first conveyance direction. The second conveyor rotates while contacting an upper face of the medium that has passed through the first conveyor to convey the medium in a second conveyance direction different from the first conveyance direction. The stacker stacks the medium conveyed by the second conveyor. The binder binds a plurality of the media stacked on the stacker. The driver rotates the first conveyor and the second conveyor and moves the second conveyor to a conveyance position where the second conveyor contacts the medium stacked on the stacker and conveys the medium and a retraction position where the second conveyor is retracted from the medium stacked on the stacker. The input unit (receiver) receives an input from a user. The opening is an opening through which the plurality of the media is manually fed toward the stacker. The controller controls the image forming apparatus, the binder, and the driver, moves the second conveyor from the conveyance position to the retraction position in a case where a manual binding instruction is input to the input unit, causes the binder to bind the plurality of the media manually fed through the opening, and causes the image forming apparatus to wait for image formation until the plurality of the media bound by the binder is discharged through the opening in a case where the image forming apparatus is instructed to form an image when the second conveyor is in the retraction position.

### Aspect 9

In Aspect 9, a non-transitory recording medium stores a program which, when executed by one or more processors of a medium processing apparatus, causes the one or more processors to perform a method, including controlling a driver to move a second conveyor to a conveyance position and a retraction position. The medium processing apparatus including a first conveyor, a second conveyor, a stacker, a binder, and a driver. The first conveyor nips a medium and rotates to convey the medium in a first conveyance direction. The second conveyor rotates while contacts an upper face of the medium that has passed through the first conveyor to convey the medium in a second conveyance direction different from the first conveyance direction. The stacker stacks the medium conveyed by the second conveyor. The binder binds a plurality of the media stacked on the stacker. The driver rotates the first conveyor and the second conveyor and moves the second conveyor to a conveyance position where the second conveyor contacts the medium stacked on the stacker and conveys the medium and a retraction position where the second conveyor is retracted from the medium stacked on the stacker.

### Aspect 10

In Aspect 10, a non-transitory recording medium stores a program which, when executed by one or more processors of an image forming system, causes the one or more processors to perform a method, including moving a second conveyor from a conveyance position to a retraction position in a case where a manual binding instruction is input to an input unit (receiver), causing a binder to bind a plurality of media manually fed through an opening, and causing an image forming apparatus to wait for image formation until the plurality of media bound by the binder is discharged through the opening in a case where the image forming apparatus is instructed to form an image when the second conveyor is in the retraction position. The image forming system includes an image forming apparatus, a first conveyor, a second conveyor, a stacker, a binder, a driver, an input unit (receiver), and an opening. The image forming apparatus forms an image on a medium. The first conveyor nips the medium supplied from the image forming apparatus and rotates to convey the medium in a first conveyance direction. The second conveyor rotates while contacting an upper face of the medium that has passed through the first conveyor to convey the medium in a second conveyance direction different from the first conveyance direction. The stacker stacks the medium conveyed by the second conveyor. The binder binds a plurality of the media stacked on the stacker. The driver rotates the first conveyor and the second conveyor and moves the second conveyor to a conveyance position where the second conveyor contacts the medium stacked on the stacker and conveys the medium and a retraction position where the second conveyor is retracted from the medium stacked on the stacker. The input unit receives an input from a user. The opening is an opening through which the plurality of the media is manually fed toward the stacker.

### Aspect 11

In Aspect 11, a medium processing apparatus includes a first conveyor, a second conveyor, a stacker, a binder, and a driver. The first conveyor nips a medium and rotate to convey the medium in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between a conveyance position where the second conveyor contacts the medium on the stacker to convey the medium and a retraction position where the second conveyor is retracted from the medium on the stacker.

### Aspect 12

In Aspect 12, in the medium processing apparatus of Aspect 11, the driver includes a rotation driver and a slide driver. The rotation driver rotates the first conveyor and the second conveyor. The slide driver slides the first conveyor, in a main scanning direction orthogonal to the first conveyance direction and the second conveyance direction, between an engagement position where the second conveyor is engaged with the rotation driver to be movable to the retraction position and a release position where the second conveyor is released from the rotation driver to be stayed at the conveyance position.

### Aspect 13

In Aspect 13, in the medium processing apparatus of Aspect 12, the first conveyor includes a drive shaft and a first engagement portion. The drive shaft is rotated by a driving force transmitted from the rotation driver. The first engagement portion is on the drive shaft. The second conveyor includes an arm, a roller, and a second engagement portion. The arm is rotatably supported by the drive shaft. The roller is at a distal end of the arm and rotatable by the driving force transmitted from the rotation driver. The second engagement portion is engaged with the first engagement portion when the first conveyor is at the engagement position, and is released from the first engagement portion when the first conveyor is at the release position. The arm rotates between the conveyance position and the retraction position by the driving force transmitted from the rotation driver via the drive shaft when the first conveyor is at the engagement position.

### Aspect 14

In Aspect 14, the medium processing apparatus of any one of Aspects 11 to 13 further includes a main scanning direction aligner to, when the second conveyor is at the retraction position, move the media on the stacker in a main scanning direction orthogonal to the first conveyance direction and the second conveyance direction, and align positions of the media on the stacker in the main scanning direction.

### Aspect 15

In Aspect 15, the medium processing apparatus of any one of Aspects 11 to 14 further includes an apparatus body, a receiver, an opening, and circuitry. The receiver receives an operational input. The opening is an opening through which the media is fed from outside the apparatus body to the stacker. The circuitry is to control the driver and the binder, move the second conveyor from the conveyance position to the retraction position, and cause the binder to bind the media fed to the stacker through the opening, when a binding instruction as the operational input is input to the receiver.

### Aspect 16

In Aspect 16, an image forming system includes an image forming apparatus that forms an image on a medium, and the medium processing apparatus of any one of Aspects 11 to 15 that processes the medium supplied from the image forming apparatus.

### Aspect 17

In Aspect 17, the image forming system of Aspect 16 further includes a sensor, an opening, and circuitry. The sensor detects the medium stacked on the stacker. The opening is an opening through which the media is fed from outside to the stacker. The circuitry is to control the driver and the binder, move the second conveyor from the conveyance position to the retraction position, and cause the binder to bind the media fed to the stacker through the opening, when the medium is not supplied from the image forming apparatus and the sensor detects the medium.

### Aspect 18

In Aspect 18, an image forming system includes an image forming apparatus, a first conveyor, a second conveyor, a stacker, a binder a driver, a receiver, an opening, and circuitry. The image forming apparatus forms an image on a medium. The first conveyor nips a medium and rotates to convey the medium supplied from the image forming apparatus in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between a conveyance position where the second conveyor contacts the medium on the stacker to convey the medium and a retraction position where the second conveyor is retracted from the medium on the stacker. The receiver receives an operational input. The opening is an opening through which the media is fed from outside to the stacker. The circuitry is to control the driver and the binder, move the second conveyor from the conveyance position to the retraction position when a binding instruction as the operational input is input to the receiver, cause the binder to bind the media fed to the stacker through the opening, cause the binder to bind the plurality of the media manually fed through the opening, and cause the image forming apparatus to wait for image formation until the media bound by the binder is ejected through the opening, in a case where the image forming apparatus is instructed to form an image, with the second conveyor in the retraction position.

### Aspect 19

In Aspect 19, a non-transitory recording medium stores a program which, when executed by one or more processors of a medium processing apparatus, causes the one or more processors to perform a method, including controlling a driver to move a second conveyor to a conveyance position and a retraction position. The medium processing apparatus includes a first conveyor, the second conveyor, a stacker, a binder, and the driver. The first conveyor nips a medium and rotates to convey the medium supplied from the image forming apparatus in a first conveyance direction. The second conveyor rotates while contacting an upper face of the medium that has passed through the first conveyor, and conveys the medium in a second conveyance direction different from the first conveyance direction. The stacker stacks media including the medium conveyed by the second conveyor. The binder binds the media stacked on the stacker. The driver drives the first conveyor and the second conveyor, and moves the second conveyor between the conveyance position where the second conveyor contacts the medium on the stacker to convey the medium and the retraction position where the second conveyor is retracted from the medium on the stacker.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a first conveyor to nip a medium and rotate to convey the medium in a first conveyance direction;
a second conveyor to:
rotate while contacting an upper face of the medium that has passed through the first conveyor; and
convey the medium in a second conveyance direction different from the first conveyance direction;
a stacker to stack media including the medium conveyed by the second conveyor;
a binder to bind the media stacked on the stacker; and
a driver to:
drive the first conveyor and the second conveyor; and
move the second conveyor between:
a conveyance position where the second conveyor contacts the medium on the stacker to convey the medium; and
a retraction position where the second conveyor is retracted from the medium on the stacker.

2. The medium processing apparatus according to claim 1,
wherein the driver includes
a rotation driver to rotate the first conveyor and the second conveyor, and
a slide driver to slide the first conveyor, in a main scanning direction orthogonal to the first conveyance direction and the second conveyance direction, between:
an engagement position where the second conveyor is engaged with the rotation driver to be movable to the retraction position; and
a release position where the second conveyor is released from the rotation driver to be stayed at the conveyance position.

3. The medium processing apparatus according to claim 2,
wherein the first conveyor includes:
a drive shaft rotated by a driving force transmitted from the rotation driver; and
a first engagement portion on the drive shaft,
the second conveyor includes:
an arm rotatably supported by the drive shaft;
a roller at a distal end of the arm and rotatable by the driving force transmitted from the rotation driver; and
a second engagement portion:
engaged with the first engagement portion when the first conveyor is at the engagement position; and
released from the first engagement portion when the first conveyor is at the release position, and
the arm rotates between the conveyance position and the retraction position by the driving force transmitted from the rotation driver via the drive shaft when the first conveyor is at the engagement position.

4. The medium processing apparatus according to claim 1, further comprising a main scanning direction aligner to, when the second conveyor is at the retraction position:
move the media on the stacker in a main scanning direction orthogonal to the first conveyance direction and the second conveyance direction; and
align positions of the media on the stacker in the main scanning direction.

5. The medium processing apparatus according to claim 1, further comprising:
an apparatus body;
a receiver unit to receive an operational input;
an opening through which the media is fed from outside the apparatus body to the stacker; and
circuitry configured to:
control the driver and the binder;
move the second conveyor from the conveyance position to the retraction position; and
cause the binder to bind the media fed to the stacker through the opening,
when a binding instruction as the operational input is input to the receiver.

6. An image forming system comprising:
an image forming apparatus to form an image on a medium; and
the medium processing apparatus according to claim 1 to process the medium supplied from the image forming apparatus.

7. The image forming system according to claim 6, comprising:
a sensor to detect the medium stacked on the stacker;
an opening through which the media is fed from outside to the stacker; and
circuitry configured to:
control the driver and the binder;
move the second conveyor from the conveyance position to the retraction position; and
cause the binder to bind the media fed to the stacker through the opening,
when the medium is not supplied from the image forming apparatus and the sensor detects the medium.

8. An image forming system comprising:
an image forming apparatus to form an image on a medium;
a first conveyor to nip a medium and rotate to convey the medium supplied from the image forming apparatus in a first conveyance direction;
a second conveyor to:
rotate while contacting an upper face of the medium that has passed through the first conveyor; and
convey the medium in a second conveyance direction different from the first conveyance direction;
a stacker to stack media including the medium conveyed by the second conveyor;
a binder to bind the media stacked on the stacker; and
a driver to:
drive the first conveyor and the second conveyor; and
move the second conveyor between:
a conveyance position where the second conveyor contacts the medium on the stacker to convey the medium; and
a retraction position where the second conveyor is retracted from the medium on the stacker;
a receiver to receive an operational input;
an opening through which the media is fed from outside to the stacker; and
circuitry configured to:
control the driver and the binder;
move the second conveyor from the conveyance position to the retraction position when a binding instruction as the operational input is input to the receiver;
cause the binder to bind the media fed to the stacker through the opening;
cause the binder to bind the plurality of the media manually fed through the opening; and
cause the image forming apparatus to wait for image formation until the media bound by the binder is ejected through the opening,
in a case where the image forming apparatus is instructed to form an image, with the second conveyor in the retraction position.

9. A non-transitory recording medium storing a program which, when executed by one or more processors of a medium processing apparatus, causes the one or more processors to perform a method, comprising controlling a driver to move a second conveyor to a conveyance position and a retraction position, the medium processing apparatus including:
a first conveyor to nip a medium and rotate to convey the medium supplied from the image forming apparatus in a first conveyance direction;
the second conveyor to:
rotate while contacting an upper face of the medium that has passed through the first conveyor; and
convey the medium in a second conveyance direction different from the first conveyance direction;
a stacker to stack media including the medium conveyed by the second conveyor;
a binder to bind the media stacked on the stacker; and
the driver to:
drive the first conveyor and the second conveyor; and
move the second conveyor between:
the conveyance position where the second conveyor contacts the medium on the stacker to convey the medium; and
the retraction position where the second conveyor is retracted from the medium on the stacker.
